(19) United States
(12) Patent Application Publication
(10) Pub. No.: US 2018/0012164 A1
(43) Pub. Date: Jan. 11, 2018

(54) METHOD OF PLANNING FOR DEPLOYMENT OF FACILITIES AND APPARATUS ASSOCIATED THEREWITH

(71) Applicant: Conduent Business Servcies, LLC, Dallas, TX (US)

(72) Inventors: Ragavendran Gopalakrishnan, Bangalore (IN); Arpita Biswas, Kolkata (IN); Alefiya Lightwala, Indore (IN); Abhishek Tripathi, Bangalore (IN); Partha Dutta, Bangalore (IN); Daniel H. Greene, Sunnyvale, CA (US)

(73) Assignee: Conduent Business Services, LLC, Dallas, TX (US)

(21) Appl. No.: 15/205,206

(22) Filed: Jul. 8, 2016

(51) Int. Cl. G06Q 10/06

(52) U.S. Cl. CPC G06Q 10/06313; G06Q 2240/00

(57) ABSTRACT

A method of planning for deployment of facilities includes modeling maximization of satisfaction of demands for service in a geographic area (packing constraint) and minimization of distance traveled from locations of interest within the geographic area to deployed facilities (covering constraint) as a mixed packing and covering problem with a service level constraint on the deployed facilities and an overall budget constraint. Additional embodiments describe an iterative process to identify an optimized solution, an incremental process to identify incremental optimized solutions in relation to release of incremental budgets for deployment of facilities, and deployment of facilities in which multiple private providers compete for sites and subsidies from an authoritative agency. Various embodiments of facility deployment planning systems associated with the method are also provided, as well as various embodiments of non-transitory computer readable medium associated with the method.

### BACKGROUND

This disclosure presents various embodiments of a method of planning for deployment of facilities. In several embodiments, the method is applied to deployment of electric vehicle recharging stations. However, the method can also be applied to deployment of bus stop shelters, parking lots, healthcare kiosks, and other types of facilities. Various embodiments of a facility deployment planning system are also provided. The disclosure also presents various embodiments of a computer-readable medium storing program instructions that are associated with the method.

Facility location is an on-going problem in operations research where multiple facilities need to be optimally placed over a geographical region, typically, with the aim of minimizing the cost of deployment and the cost of serving the demand, and under various constraints. In practice, the deployment is often done in an incremental manner (or in stages), primarily due to progressive release of funds to deploy the facilities. There can also be other reasons, such as limits on the concurrent availability of resources to construct the facilities and the incremental nature of government approvals. One of the challenges in incremental deployment is to provide a systematic framework for progressively improving the quality of overall placement from a given stage to subsequent stages, while taking into account the (monetary) budget and (residual) demand at each stage.

Facility location problems (FLPs) have been studied in operations research and computer science literatures. Solutions to FLP may aim to minimize the total cost (typically composed of the cost of opening the facilities, and the cost of connecting demand sites to facilities) while covering or connecting all demand sites. However, existing works do not model the facility location problem with an objective to maximize satisfied demand in the presence of packing constraints (i.e., budget constraints), covering constraints (i.e., reachability constraints), and SLA constraints (constraints on waiting times at facilities). In one solution to FLP, Vazirani describes an approximation algorithm (e.g., k-center) in which there is an upper limit k on the number of facilities to be opened, while minimizing the maximum distance from a demand site to its nearest facility. Although the Vazirani k-center algorithm can be used to optimize reachability, it does not consider demand satisfaction and bounds on waiting times at facilities. For additional information on the Vazirani k-center algorithm, see Vazirani, Approximation Algorithms, Springer, 2001, pp. 47-53, the content of which is fully incorporated herein by reference in its entirety.

Mixed packing and covering problems have been studied for fractional decision variables, as well as for integer decision variables, but without considering knapsack packing or set covering constraints. Incremental or multi-period FLP, where facilities are deployed over time, has been studied before, but without considering minimizing the maximum distance to a facility in each stage of the deployment.

### BRIEF DESCRIPTION

In one aspect, a method of planning for deployment of facilities is provided. In one embodiment, the method includes processing a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses; receiving a set of estimated site demands for service from a demand prediction subsystem, wherein the set of estimated site demands for service includes an estimated site demand for service (dᵢ) for each candidate site of the set of candidate sites; processing the set of candidate sites, the set of estimated site demands for service, and a service requirement constraint using a queuing algorithm to determine service units (Nᵢ) required to satisfy the service requirement constraint at each candidate site, wherein the determined service units for each candidate site form a set of service unit quantities; and processing the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.

In another aspect, an apparatus to facilitate planning for deployment of facilities is provided. In one embodiment, the apparatus includes at least one processor and associated memory; and a non-transitory storage device configured to store program instructions that, when executed by the at least one processor, cause the apparatus to perform a method of planning for deployment of facilities; wherein the at least one processor is configured to process a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses; wherein the at least one processor is configured to receive a set of estimated site demands for service from a demand prediction subsystem, wherein the set of estimated site demands for service includes an estimated site demand for service (dᵢ) for each candidate site of the set of candidate sites; wherein the at least one processor is configured to process the set of candidate sites, the set of estimated site demands for service, and a service requirement constraint using a queuing algorithm to determine service units (Nᵢ) required to satisfy the service requirement constraint at each candidate site, wherein the determined service units for each candidate site at each reachability radius form a set of service unit quantities; wherein the at least one processor is configured to process the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.

In yet another aspect, a non-transitory computer-readable medium storing program instructions that, when executed by at least one processor, cause a corresponding processor-controlled apparatus to perform a method of planning for deployment of facilities. In one embodiment, the method includes processing a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses; receiving a set of estimated site demands for service from a demand prediction subsystem, wherein the set of estimated site demands for service includes an estimated site demand for service (dᵢ) for each candidate site of the set of candidate sites; processing the set of candidate sites, the set of estimated site demands for service, and a service requirement constraint using a queuing algorithm to determine service units (Nᵢ) required to satisfy the service requirement constraint at each candidate site, wherein the determined service units for each candidate site form a set of service unit quantities; and processing the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.

### BRIEF DESCRIPTION OF THE DRAWINGS

FIG. 1 provides a functional block diagram of an exemplary embodiment of a system architecture associated with planning for deployment of facilities;

FIG. 2 provides a graph depicting an exemplary set of optimal demands for service for a reachability radius range from an inner radius to an outer radius;

FIGS. 3A and 3B provides a pseudo code listing for an exemplary embodiment of a process for planning deployment of facilities;

FIG. 4 provides a functional block diagram of another exemplary embodiment of a system architecture associated with planning for deployment of facilities;

FIGS. 5 and 6 provides graphs depicting experimental feasibility results associated with an exemplary embodiment of a process for planning deployment of facilities;

FIGS. 7 and 8 provides graphs depicting experimental performance results associated with an exemplary embodiment of a process for planning deployment of facilities;

FIG. 9 provides a graph depicting experimental optimization results associated with the experimental performance results under various demand-reachability trade-offs;

FIG. 10 is a flowchart of an exemplary embodiment of a process for planning deployment of facilities;

FIG. 11, in combination with FIG. 10, is a flowchart of another exemplary embodiment of a process for planning deployment of facilities;

FIGS. 12A and 12B, in combination with FIGS. 10 and 11, provide a flowchart of still yet another exemplary embodiment of a process for planning deployment of facilities;

FIG. 13, in combination with FIG. 10, is a flowchart of another exemplary embodiment of a process for planning deployment of facilities; and

FIG. 14 is a block diagram of an exemplary embodiment of a facility deployment planning system.

### DETAILED DESCRIPTION

Various embodiments of a solution to the facility location problem are disclosed herein. The facility location problem arises in multiple domains, in particular, in the deployment of transportation infrastructure such as bus stop shelters, parking lots, and Electric Vehicle (EV) charging stations, and in the deployment of healthcare kiosks. The solutions to the facility location problem disclosed herein are primarily motivated by the application of solution to facility location problems for EV charging station placement. Due to highly variable prices and the environmental impact of fossil fuels, there is increasing interest in EVs from both individuals and organizations. Many governments have announced ambitious targets for EV adoption. A prerequisite for widespread adoption of EVs is an adequate level of deployment for public charging stations so as to satisfy current and future charging demands. The solutions disclosed herein address incremental facility location to maximize satisfied demand in the presence of constraints on budget and reachability.

Facility location problems naturally arises in EV charging station placement where a set of charging stations (CS) need to be incrementally deployed in a region with budget released over time. There is a set of candidate sites where charging stations could be placed. At each candidate site, there is a predicted demand for EV charging that would be satisfied if a charging station were to be placed there. At each deployed charging station, a Service Level Agreement (SLA) constraint should be met, namely, the average time an EV has to wait before it can start charging is within a specified bound. The cost of deployment of a charging station varies across the candidate sites, partly because the number of charging outlets necessary to meet the SLA constraints varies across these sites.

There are three major objectives in effectively deploying facilities, such as EV charging stations: i) Maximize satisfaction of the total demand for EV charging; ii) Given a set of locations of interest, ensure that there is a deployed charging station within a short driving range of every location in the set (The locations of interest could include the candidate sites as well, in which case the interpretation is that, even if a charging station is not deployed at a candidate site, there is one nearby.); and iii) Maximize the reachability of the charging stations from the locations of interest (i.e., minimize the driving distance between charging stations and locations of interest). The goal is to find an optimal incremental deployment of charging stations that best balances these competing objectives, subject to the available budget that is released over time.

The various embodiments disclosed herein present systems and methods for modeling and solving a facility location problem that seeks to maximize the satisfied demand and reachability subject to covering and budget constraints, in an incremental manner over a period of time. In each stage, a budget is allocated for the deployment, and a set of candidate sites is specified. Each candidate site is associated with a deployment cost and a predetermined demand. The facility location problem for a stage is thus formulated using a combination of packing constraints (i.e., budget constraints) and covering constraints (i.e., reachability constraints). Using these inputs, various embodiments described herein present a method for solving the facility location problem in an iterative manner where, in each iteration, a knapsack and a set cover problem are solved. It is recognized that the solution is suboptimal since the primary facility location problem, and the associated knapsack and set cover problems, are non-deterministic polynomial-time hard (NP-Hard). Further embodiments of the method are extended to cases where there are multiple service providers for building the facilities, each with their respective budgets, and a government agency allocates grants to these providers (subject to its own budget) for building the facilities at selected locations, so as to maximize the satisfied demand subject to the same covering constraints (i.e., reachability constraints) as before. An exemplary embodiment of the method is evaluated for the EV charging station placement problem using charging data from Northeast England.

Various embodiments of systems and methods for incremental facility location, including applications to resolution of electric vehicle charging station placement problems. The various embodiments include the following features in various combinations: i) modeling demand maximization with constraints on budget and coverage with a mixed packing and covering problem; ii) providing an iterative method for such modeling by alternatingly solving the packing and covering problems; iii) implementing incremental placement over time by improving reachability to the nearest selected facility location; and iv) considering government grant allocation for building facilities in a multi-provider setting that takes into account both government budgets and provider budgets.

As for modeling demand maximization with constraints on budget and coverage, the facility location problem is modeled as a mixed packing and covering problem to maximize the demand satisfied by the placement while ensuring that a specified budget is not exceeded (packing constraint) and, for any among a specified set of locations of interest, to ensure there is a nearby selected site (covering constraints).

As for providing an iterative method for such modeling, the modeled mixed packing and covering problem has knapsack and set cover as sub-problems, both of which are NP-Hard to solve optimally. These embodiments propose a (sub-optimal) heuristic for solving the above mixed packing and covering problem using an iterative method where, in each iteration, an instance of a knapsack function and an instance of a set cover function are sub-optimally solved.

As for implementing incremental placement over time, to handle the common case where facilities are deployed incrementally over time, these embodiments propose a method that, in each stage, considers a different covering constraint so as to minimize the maximum distance of locations of interest from their nearest deployed facility.

As for considering government grant allocations, these embodiments take into account a multi-provider setting in which both governments and providers have limited budgets. Large scale deployment of facilities typically involves multiple service providers (builders of facilities) and the government may provide grants to incentivize service providers to build facilities in some candidate locations that are unpopular or have a low demand. The government may have an upper limit on the total grant money given to the providers and each provider may have an upper limit on how much they can spend for building facilities at selected sites assigned to them. These embodiments provide models and methods to solve the incremental facility location problem under such multiple budget constraints.

Recent increases in adoption of EVs have brought more attention to charging station placement. For example, placement of charging station based on predicted demand has been studied in U.S. Pat. App. Publication No. 2013/0222158 to Dai et al., U.S. Pat. App. Publication No. 2012/0203726 to Klabjan, et al., Wagner et. al., Smart City Planning—Developing an Urban Charging Infrastructure for Electric Vehicles, European Conference on Information Systems, 2014, and Chen et al., The electric vehicle charging station location problem: A parking-based assignment method for Seattle, Transportation Research Board 92nd Annual Meeting, Vol. 340, 2013. The contents of these four documents are fully incorporated herein by reference in their entirety. These works do not consider incremental placement or simultaneous constraints on budget, coverage, and waiting times. Charging station placement in the presence of multiple service providers has been studied by Cadre, but Cadre did not consider such placement in the presence of a government agency that grants subsidies to the providers. In addition, Cadre did not consider maximizing the demand satisfied or incremental deployment. See Cadre, Infrastructure topology optimization under competition through cross-entropy, Journal Of The Operational Research Society, Palgrave Macmillan, 2014 the contents of which are fully incorporated herein by reference in its entirety.

A demand prediction system implementing a demand prediction model can be used as an input module for the proposed methods described herein. Demand prediction at candidate sites for EV charging stations can be based on any demand prediction model suitable for the facility location problem.

The various embodiments of solutions to the facility location problem described herein present a solution for generic incremental facility location while taking into account demand, budget, waiting times, and reachability. These solutions can be used for placement of other public facilities, such as shelters for public transportation stops, parking lots, and healthcare kiosks (e.g., HealthSpot), as well as the EV charging stations discussed in exemplary embodiments.

The various embodiments of solutions to the facility location problem disclosed here can be useful for EV charging station operators and government agencies to determine suitable sites and plan for charging station deployment. As mentioned above, it may also be useful for placement of other facilities with an aim to maximize satisfied demand, while taking into account budget, coverage and waiting times at facilities such as shelters for public transportation stops, parking lots, and healthcare facilities.

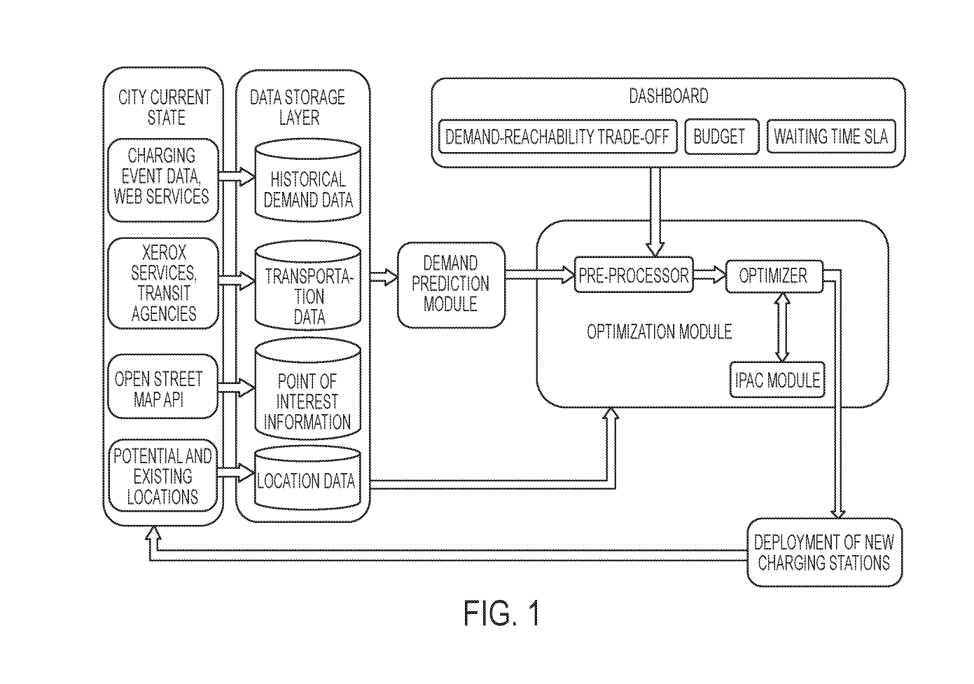

With reference to FIG. 1, a system architecture for an exemplary embodiment of an overall system shows a data storage layer, a dashboard, and an optimization module with external inputs and an external output. The external inputs include representations of a current state of an area of interest and a demand prediction module. The external output includes deployment of new facilities (e.g., charging stations). The data storage layer provides a transparent interface to store and retrieve data. It stores historical demand data for existing charging stations, transportation data, points of interest data, as well as the candidate site data, for potential charging stations. Historical demand data includes charging event data collected from programs, such as a government-funded Plugged-in-Places (PiP) program in the United Kingdom, and from available web services. Transportation data like infrastructure and traffic information is obtained from various transit agencies and private sector businesses. Points-of-Interest (PoI) information describing the type of activities happening in various places of a city is obtained from a mapping utility, such as OpenStreetMap (OSM). The details of the candidate sites for new charging stations as well as sites where existing charging stations are located are obtained from the current state of the city using a combination of charging event data (e.g., PiP data) and PoI data (e.g., OSM data). The data is fed into the demand prediction module which captures how PoI and transportation data are correlated with charging station demand. The demand prediction module uses this information to predict demand at the candidate sites using a statistical model.

The optimization module takes the current state of the city as input, including the set of candidate sites, the set of locations of interest to be covered, the predicted demand for the candidate sites (the output of the demand prediction module), the demand-reachability trade-off parameter, a budget for placing the charging stations, and the SLA constraints on the maximum mean waiting times at facilities. The optimization module includes three sub-modules, namely, a preprocessor, an optimizer and an IPAC module. The preprocessor computes pairwise distances from locations of interest to the candidate sites, estimates the facility deployment cost at each candidate site, and sends these results to the optimizer. The goal of the optimizer is to choose the candidate sites for facility deployment that achieves a given trade-off between the two competing objectives of maximizing the total demand satisfied and maximizing reachability, while keeping the total cost under the budget and ensuring that at least one charging station is reachable from each location of interest. This requires solving a mixed packing and covering problem for each reachability radius for which the optimizer invokes the IPAC module.

The results output from the optimization module are implemented by deploying facilities at the selected sites. After deployment, the current state of the city changes. More facilities can be placed incrementally by updating the available budget and repeating the entire process. The mathematical model for the incremental facility deployment problem is explained below with more detail regarding the methods for solving the mixed packing and covering optimization problem.

Notation and Problem Formulation

Let [symbol] ={1, 2, . . . , | [symbol] |} denote the set of all candidate sites for placing a facility. Let rε [symbol] ₊ denote the desired “reachability radius,” that is, the maximum distance to be traveled in order to reach a facility. Let [symbol] denote the set of all locations of interest that are desired to be “covered,” that is, lie within the reachability radius from at least one facility. Let B denote the total budget available to build facilities.

For each candidate site iε [symbol] , i) xᵢε{0, 1} is the decision variable denoting whether or not a facility is installed at i; ii) dᵢε [symbol] ₊ is the demand for service at i; iii) cᵢε [symbol] ₊ is the cost of setting up a facility at i; and iv) Sᵢ^{r}⊂ [symbol] is the cover set of i, that is, the set of locations of interest that would be “covered” if a facility were to be placed at i. In other words, Sᵢ^{r} is the set of locations of interest that are within a driving distance of r from i.

Optimizing for Demand

For a given reachability radius r, the optimization problem to be solved is the following mixed packing and covering problem:

$${max}_{\{ {x}_{i} \text{:} i ∈ ℒ \}} {\sum }_{i ∈ ℒ} {d}_{i} {x}_{i} \\ subject to {\sum }_{i ∈ ℒ} {c}_{i} {x}_{i} \leq B \\ {\sum }_{i ∈ ℒ : 𝓁 ∈ {S}_{i}^{r}} {x}_{i} \geq 1 ∀ 𝓁 ∈ 𝒥 \qquad ( 1 )$$

Note that the total demand satisfied by installing facilities at a selected subset of candidate sites may be less than the sum of the predicted demands at those sites due to overlapping reachability regions. However, this effect is ignored in order to keep the optimization problem simpler.

Optimizing for Reachability

In addition to maximizing the demand for a given reachability radius, it may also be desirable to minimize the reachability radius itself. Without loss of generality, assume that r E [R^{min}, R^{max}], where:

$${R}^{min} = {max}_{𝓁 ∈ 𝒥} {min}_{i ∈ ℒ} dist ( 𝓁 , i ) \\ {R}^{max} = {max}_{𝓁 ∈ 𝒥} {min}_{i ∈ ℒ} dist ( 𝓁 , i ) \qquad ( 2 )$$

where dist(l,i) denotes the distance between locations l and i according to an underlying transportation network. The lower bound for r stems from the observation that when r<R^{min}, even if facilities are placed at all candidate sites, there would be at least one uncovered location of interest; so, no feasible solution exists for such r. The upper bound for r follows from the fact that even if there is only a single selected site where a facility is placed, and the solution is feasible, R^{max} is, by definition, the maximum distance to be traveled in order to reach that facility.

Let D*(r) denote the maximum demand covered (obtained from a solution to equation (1)) for a given reachability radius r. For convenience, define D*(r)=0 if equation (1) is infeasible. For example, equation (1) may be infeasible due to insufficient budget for small values of r. If αε[0,1] is a given trade-off parameter, at a higher level, the objective is the following:

$${max}_{r ∈ [ {R}^{min} , {R}^{max} ]} α \frac{{D}^{*} ( r )}{{\sum }_{i ∈ ℒ} {d}_{i}} + ( 1 - α ) \frac{{R}^{max} - r}{{R}^{max} - {R}^{min}} \qquad ( 3 )$$

The following two observations are presented concerning D*(r): i) D*(r) is non-decreasing, since for any two radii r₁, r₂ with r₁≦r₂, the feasible set of (1) for r₁ is a subset of that for r₂; and ii) Let [symbol] ={dist(l,i)|lε [symbol] , iε [symbol] , dist(l,i)≧R^{min}} denote the set of all distances from a location of interest to a candidate site that is at least R^{min}. This set may be represented as [symbol] ={r₁, r₂, . . . , [symbol] }; where R^{min}=r₁<r₂< . . . < [symbol] =R^{max}. Next, for 1≦m≦| [symbol] |, then rₘ≦r≦rₘ₊₁, D*(r)=D*(rₘ). In other words, D*(r) is a step function and remains unchanged between values of r that do not correspond to location of interest-to-site distances.

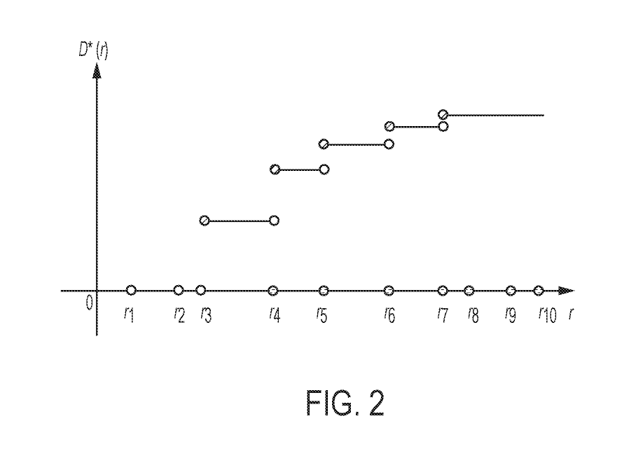

With reference to FIG. 2, a sample plot of the function D*(r) is depicted when | [symbol] |=10. Given these observations, it can be seen that the value(s) of r at which the objective function in Equation (3) attains its maximum must be among the elements in [symbol] . Therefore, solving Equation (3) is equivalent to solving the following optimization problem:

$$α \frac{{D}^{*} ( r )}{ {d}_{i}} + ( 1 - α ) \frac{{R}^{max} - r}{{R}^{max} - {R}^{min}} \qquad ( 4 )$$

Preprocessing

While the sets of candidate sites [symbol] , locations of interest [symbol] , and demands [symbol] are given as inputs, the sets of distances [symbol] , and facility costs [symbol] are not directly provided as inputs. These parameters are pre-computed before solving Equation (4). What is given, instead, is a distance function dist( ) from an underlying transportation network and SLA constraints (maximum average waiting time before service) for the facilities.

Computing Distance Set

It is straightforward to determine the pairwise distances from any candidate site in [symbol] to any location of interest [symbol] from the distance function provided by the underlying transportation network. Then, R^{min} can be computed using Equation (2), following which [symbol] can be computed by sorting the pairwise distances in increasing order and removing duplicates and distances less than R^{min}.

Computing Facility Costs

Each candidate facility is modeled at location i as a multi-server queue that follows an M/M/Nᵢ discipline, where Nᵢε [symbol] ₊ is the number of serving units to be set up. Customers arrive at the queue according to a Poisson process with rate λᵢ per time unit. The service time for each customer is exponentially distributed with mean 1/μᵢ time units. λᵢ can be derived from the demand dᵢ, whereas μᵢ can be derived from existing data on the average customer service time in similar facilities. These derivations are explained in more detail below in the context of a specific use case. The average time a customer waits before service is then given by the following equation:

$$𝔼 [ W ] = \frac{ErlC ( {N}_{i} , \frac{{λ}_{i}}{{μ}_{i}} )}{{N}_{i} {μ}_{i} - {λ}_{i}} \\ where \\ ErlC ( N , ρ ) = ( \frac{{ρ}^{N}}{N !} \frac{N}{N - ρ} ) / ( {\sum }_{j = 0}^{N - 1} \frac{{ρ}^{i}}{j !} + \frac{{ρ}^{N}}{N !} \frac{N}{N - ρ} ) \qquad ( 5 )$$

Suppose the SLA to be met is given by

[symbol]

[W]≦tᵢ (6)

Then, because [symbol] [W], as expressed in Equation (5), is a decreasing function of Nᵢ, the smallest Nᵢ (e.g., using binary search) is chosen in order to satisfy Equation (6).

After the required number of service units Nᵢ is determined, the setup cost cᵢ for a facility at location i can be derived using existing data per unit cost, which can include construction, as well as land costs. This is also explained in more detail below in the context of the specific use case.

Optimizer Module

The goal of the optimizer module is to solve the optimization problem of Equation (4). In order to do so, the optimizer module iteratively calls the IPAC module to compute D*(r) by solving Equation (1) for each reachability radius rε [symbol] . Note that before each call to the IPAC module, the cover sets ST for each candidate site i E L are computed as Sᵢ^{r}={lε [symbol] dist(l,i)≦r}. Thus, the objective function of Equation (4) is evaluated for each rεR and the maximum identified.

Solving the Mixed Packing and Covering Problem

A heuristic for the mixed packing and covering problem of Equation (1) is provided by breaking it down into two sub-problems: i) a 0-1 knapsack problem and ii) a weighted set cover problem.

The 0-1 Knapsack Problem

Equation (7) defines the packing problem:

$${max}_{\{ {x}_{i} \text{:} i ∈ ℒ \}} {\sum }_{i ∈ ℒ} {d}_{i} {x}_{i} \\ subject to {\sum }_{i ∈ ℒ} {c}_{i} {x}_{i} \leq B \qquad ( 7 )$$

Let KNAPSACK ( [symbol] , [symbol] , [symbol] , B) denote any method that solves Equation (7). It need not be optimal, but it must be nontrivial in the sense that any solution returned by the method must be maximal. In other words, it should not be possible to add another item and still satisfy the packing constraint.

The Weighted Set Cover Problem.

Equation (8) defines the covering problem:

$${min}_{\{ {x}_{i} : i ∈ ℒ \}} {\sum }_{i ∈ ℒ} {c}_{i} {x}_{i} \\ subject to {\sum }_{i ∈ ℒ : 𝓁 ∈ {S}_{i}^{r}} {x}_{i} \geq 1 ∀ 𝓁 ∈ 𝒥 \qquad ( 8 )$$

Let WSETCOVER ( [symbol] , [symbol] , [symbol] , [symbol] ) denote any method that solves Equation (8). It need not be optimal, but it must be nontrivial in the sense that any solution returned by the method must be minimal. In other words, it should not be possible to remove an item and still satisfy the covering constraints.

The Iterative Pack and Cover (IPAC) Heuristic

The available budget could be used very differently if the problem had been a pure packing problem (where maximizing the demand is the only concern) or a pure covering problem (where satisfying covering constraints is the only concern). Thus, a good solution to the mixed packing and covering problem is one where an appropriate balance is achieved by dividing the available budget between these two concerns. The core idea behind the IPAC (Iterative Pack And Cover) heuristic is to iteratively search for such an optimal split.

In each iteration, the total available budget B is apportioned into B^{ks} and B^{wsc}, where B^{ks} is the portion of the budget used by the solution to a packing problem that determines the maximum demand that can be satisfied when constrained by a reduced budget of B−B^{wsc}. A check is performed using WSETCOVER( ) to determine whether the remaining budget B−B^{ks} is sufficient to satisfy the covering constraints left unsatisfied by the solution to the packing problem. Starting with B^{wsc}=0 (pure packing) and the corresponding solution from KNAPSACK( ) during each iteration, B^{wsc} is increased until the covering check passes, at which point the solutions of the packing and covering problems obtained in the last iteration are merged. The resulting solution is guaranteed to be a feasible solution to the mixed packing and covering problem of Equation (1). KNAPSACK( ) is then invoked one final time to use up any remaining portion of the budget. In the worst case, the iterations continue until B^{wsc}=B, at which point it becomes a pure covering problem, and if the covering check still fails, then IPAC fails to find a feasible solution to Equation (1). But, if this happens, it cannot necessarily be concluded that Equation (1) is infeasible, unless WSETCOVER( ) is an optimal method, which is unlikely in polynomial time since Equation (8) is NP-Hard.

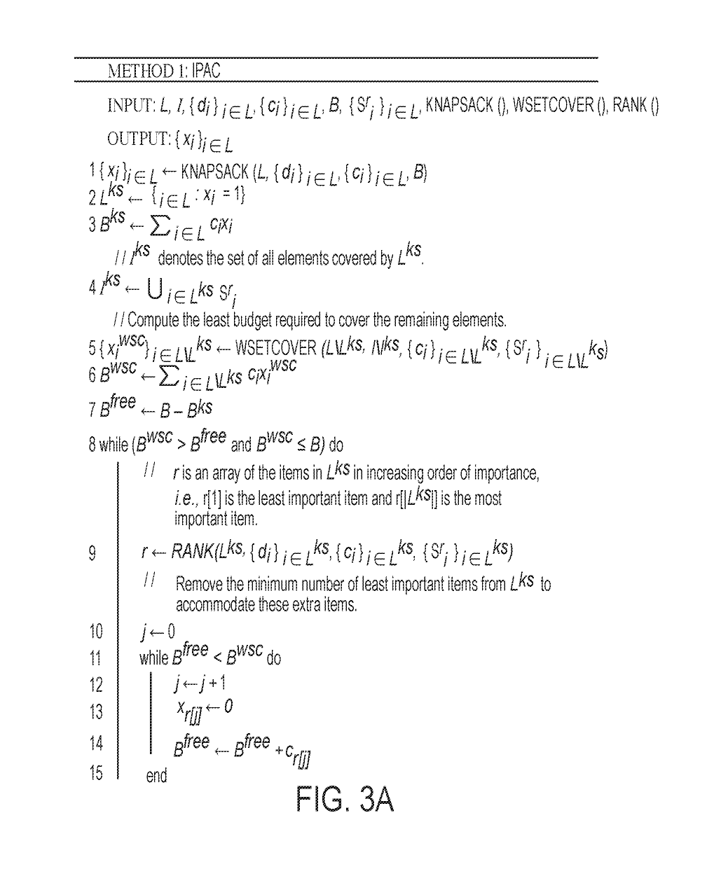

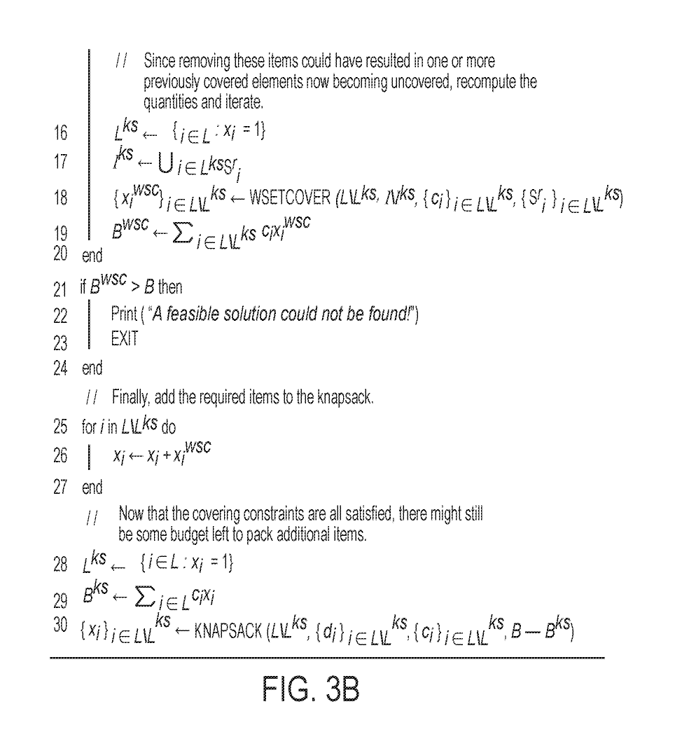

An exemplary embodiment of pseudo-code to implement the method is identified as Method 1 in FIGS. 3A and 3B. A general description of an exemplary embodiment of the method includes: i) Set B^{wsc}=0 and invoke KNAPSACK( ) to solve the pure packing problem. Let B^{ks} be the portion of the budget used by the chosen items in the knapsack. Let B^{free}=B−B^{ks} be the remainder; ii) Update B^{wsc} to be the minimum budget required to satisfy the unsatisfied covering constraints computed by invoking WSETCOVER( ) to solve the residual covering problem; iii) Repeat the following two steps until either B^{wsc}≦B^{free} or B^{wsc}>B; a) Packing: One or more items need to be removed to satisfy the reduced budget of B−B^{wsc}. In order to do so, a ranking method, RANK( ) is used to rank the currently chosen items in the knapsack according to some measure of their importance. Specific features of the RANK( ) function are discussed below in more detail. As for the packing function, keep removing items that are least important until the reduced budget constraint is satisfied. Let B^{ks} be the portion of the budget used, and let B^{free}=B−B^{ks} be the remainder; and b) Covering: Since the removal of some items in the previous step might have resulted in more unsatisfied covering constraints, invoke WSETCOVER( ) on the new residual covering problem and update B^{wsc} accordingly; iv) If B^{wsc}>B, then a feasible solution cannot be found. Otherwise, B^{wsc}≦B^{free}, and the method continues. In continuing, add the items from the solution to the last instance of WSETCOVER( ) to the remaining items in the knapsack to obtain a feasible solution; and v) Invoke KNAPSACK( ) to fill any unused portion of the budget using unallocated items.

The RANK( ) Function

The effectiveness of IPAC depends on the choice of methods for the KNAPSACK( ), WSETCOVER( ), and RANK( ) functions. There are several choices for the KNAPSACK( ) and WSETCOVER( ) functions in Vazirani. For additional information on Vazirani Knapsack algorithms, see Vazirani, Approximation Algorithms, Springer, 2001, pp. 68-73, the content of which is fully incorporated herein by reference in its entirety. For additional information on the Vazirani Set Cover algorithms, see Vazirani, Approximation Algorithms, Springer, 2001, pp. 15-26 and 108-130, the content of which is fully incorporated herein by reference in its entirety. As for the RANK( ) function, a general observation is that an item iε [symbol] is more important, or at least more desirable, if its demand dᵢ is high, and/or its cost cᵢ is low, and/or the number of elements it covers |Sᵢ| is high. Based on this, a viable candidate for RANK( [symbol] , [symbol] , [symbol] , [symbol] ) would be a method that ranks items in increasing order according to the value resulting from the equation below:

$${v}_{i} = \frac{\frac{{d}_{i}}{{\sum }_{j ∈ ℒ} {d}_{j}} + \frac{\vert {S}_{i} \vert}{\vert 𝒥 \vert}}{{c}_{i}}$$

where [symbol] = [symbol] Sᵢ denotes the set of elements covered by items in [symbol] .

Incremental Placement with Progressive Release of Budget

The case of incremental placement of facilities is considered. In practice, the budget for the deployment of facilities may be released over time. Likewise, the demand at a given candidate site and the installation cost for a facility may change over time. The above problem formulation and method may be extended to handle incremental placement.

One can consider a period of time divided into T periods, t=1, . . . , T. One may first extend earlier notation to include time periods, by superscripting them with t. Thus, B^{t}≧0 is the budget released at time (period) t, and dᵢ^{t} and cᵢ^{t} denote the predicted demand and facility cost at candidate site i at time t, respectively. There are two decision variables at time t, namely, xᵢ^{t}ε{0,1} denoting whether or not a facility is installed or already installed at i, and r^{t} denoting the reachability radius at time t. Sᵢ^{r}^{^{t}} denotes the cover set of i for a reachability radius of r^{t} at time t.

The single-period formulation in Equations (1) and (4) can be combined and generalized for the multi-period placement optimization problem as follows:

$${{x}_{i}^{t} ∈ \{ 0 , 1 \}}_{} {\sum }_{t = 1}^{T} ( α \frac{{\sum }_{i ∈ {ℒ}^{t}} {d}_{i}^{t} {x}_{i}^{t}}{{\sum }_{i ∈ {ℒ}^{t}} {d}_{i}^{t}} + ( 1 - α ) \frac{{R}^{max} - {r}^{t}}{{R}^{max} - {R}^{min}} ) \\ subject to \\ \begin{matrix}{x}_{i}^{t} \geq {x}_{i}^{t - 1} & ∀ i ∈ {ℒ}^{t - 1} ; 1 \leq t \leq T \\ {\sum }_{t = 1}^{τ} {\sum }_{i ∈ {ℒ}^{t}} {c}_{i}^{t} ( {x}_{i}^{t} - {x}_{i}^{t - 1} ) \leq {\sum }_{t = 1}^{τ} {B}^{t} & ∀ 1 \leq τ \leq T \\ {\sum }_{i ∈ {ℒ}^{t} : 𝓁 ∈ {S}_{i}^{{r}^{t}}} {x}_{i}^{t} \geq 1 & ∀ 𝓁 ∈ {𝒥}^{t} ; 1 \leq t \leq T\end{matrix} \qquad ( 9 )$$

In the above formulation, initially, xᵢ⁰=0 at all candidate sites iε [symbol] ⁰. If a facility is installed at location i at time t>0, then xᵢ^{t} is set to 1, and the first constraint ensures that the facility remains installed for subsequent periods. The second constraint ensures that the cost of (new) installations done at time τ is within the budget released at τ plus any leftover budget from previous time periods. However, since xᵢ^{t}ε{0,1}, it may not be possible to completely exhaust the available budget in a certain time period, even if desired. The third set of constraints are the covering constraints for each time period t, as a function of the reachability radius r^{t}. The objective is to maximize the fraction of demand satisfied while minimizing the reachability radius, summed over all time periods.

Before presenting a method for incremental placement, it is noted that a solution to the above problem will be useful in practice if one is able to predict future demands and installation costs at candidate sites for all T time periods with reasonable accuracy. Such predictions are difficult to make over long time periods (e.g., multiple years) because there may be many unforeseen parameters that might impact demand and cost in the long term. Therefore, a greedy heuristic which does not rely on future predictions is proposed as follows: i) At the beginning of each time period t>0, predict the current demands and estimate the current costs at candidate sites where facilities have not yet been deployed (in any previous time periods); ii) Solve the mixed packing and covering problem for remaining candidate sites using the IPAC method detailed in Method 1 (see FIGS. 3A and 3B), using the budget B^{t} available for the current period plus any leftover budget from previous periods. Note that, although the candidate sites for the current period are sites where facilities have not yet been deployed, the covering constraint for a particular location of interest lε [symbol] for the current time period t should be deemed satisfied even if a facility that was deployed in a previous time period is reachable from l within the reachability radius r^{t}; and iii) Facilities are then deployed at the selected sites.

A common and important scenario that any solution for incremental placement must handle is future increase in demand at previously deployed facilities. Even though the greedy heuristic does not directly address such a scenario by revisiting such facilities in subsequent time periods, it ensures that the increased demand at such facilities would be taken into account by the demand prediction module (see FIG. 1) in the subsequent time periods. However, one can modify the method to allow for the option of expanding the facility and add more service units in response to increasing demand by letting the set of candidate sites at time period t+1 be a superset of the set of candidate sites at time period t, that is, [symbol] ^{t+1}⊃ [symbol] ^{t}, but the costs cᵢ^{t+1} at previously selected candidate sites i would now be the cost of adding additional service units to maintain the SLA constraints. This allows the optimization problem to determine whether the right thing to do in response to increasing demand is to expand an existing facility or set up a new one nearby.

Alternate Scenario: Granting Subsidies to Facility Providers

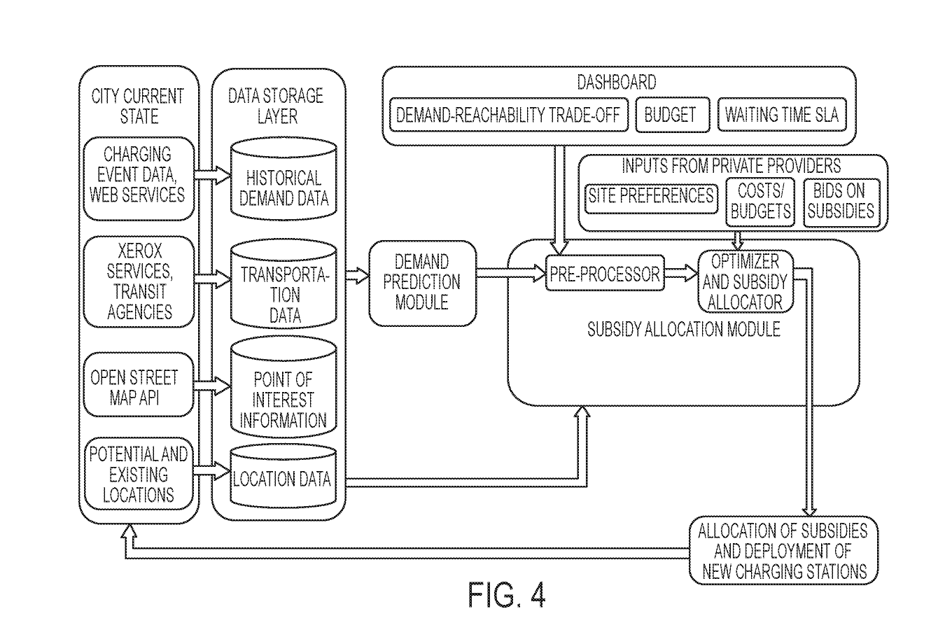

Thus far, solutions to the problem have been described for scenarios where there is a central planner, such as a government agency, that would use funds to construct facilities in a geographical region. Hence, cᵢ referred to the cost to the government agency of setting up a facility at i. An alternate scenario could be one where there is a set [symbol] ={1, 2, . . . , | [symbol] |} of private facility providers that would like to set up facilities, but would need government subsidies to incentivize them to do so. In this case, the government agency runs a grant program for subsidies where the providers specify the subsidies they need to set up facilities at the candidate sites in which they are interested. Instead of cᵢ, one can use cᵢⱼ to denote the subsidy to be paid to provider jε [symbol] at candidate site iε [symbol] , if selected. Accordingly, the modified system architecture for allocating subsidies to private providers is shown in FIG. 4.

The difference between the system architecture of FIG. 4 and that of FIG. 1 is that the optimizer and IPAC sub-module are replaced with a more comprehensive optimizer and subsidy allocator sub-module that receives additional inputs from the private providers, including: i) preferences regarding which candidate sites the providers are interested in setting up and operating facilities; ii) estimates of costs and budgets; and iii) bids on desired subsidies. The procedure may involve a screening stage (not depicted in FIG. 4) where proposals submitted by the private providers are evaluated for the accuracy/legitimacy of their cost estimation and project feasibility by a grant committee in order to determine their eligibility for further consideration. The optimizer and subsidy allocator sub-module employs a mechanism to determine the subset of candidate sites selected for deployment, the “winning” providers for each of the selected sites, and the subsidy amounts allocated to each of them. In addition to demand maximization, coverage constraints, and government agency budget constraints, the additional constraints the optimizer and subsidy allocator sub-module takes into consideration include site preference constraints of the private providers and budget constraints of the private providers. An exemplary embodiment of the method for this sub-module is a generalization of the optimizer and IPAC sub-modules of the system architecture in FIG. 1. However, other implementations of the optimizer and subsidy allocator sub-module can be accommodated as well.

A Method for Optimizer and Subsidy Allocator Sub-Module

A couple of concerns arise in allowing multiple private providers to compete for setting up and operating facilities because it is possible for private providers to express interest in multiple sites and there could be candidate sites in which no private provider has interest.

Private providers may express interest in multiple sites, even though the private provider may not have the means to build facilities at all those sites. Each private provider jε [symbol] would therefore also specify their budget Bⱼ, and their estimated Costs pᵢⱼ (after taking into account the subsidy cᵢⱼ) of building a facility at candidate site iε [symbol] . It is then the government agency's responsibility to ensure that the outcome does not violate any private provider's budget constraint. This adds additional packing constraints to the problem. Note that private providers are allowed to specify site-specific subsidies, because the amount of money they are willing to spend setting up a facility at a given site is likely to depend on that site's demand.

There could be candidate sites (e.g., with relatively low demand) that no private provider is interested in, or, even if there is interest, private providers might ask for very high subsidies, so that even the least of these would cost the government agency more than what it would cost to build a facility by itself. Furthermore, it is likely that some such sites with low demand are the only ones that cover a remote area, one of which must therefore be selected in any feasible allocation. To handle such scenarios, the government agency is modeled to be a “provider” as well, who, for every site, asks for a subsidy of cᵢ, which is the cost to the government agency of constructing a facility at that site. This is equivalent to setting a reserve subsidy at each site. Therefore, the government agency is added to the set of providers [symbol] and denoted with the index 0, to obtain the set of participants, [symbol] ={0, 1, 2, . . . , | [symbol] |}.

To recap the notation for this scenario, [symbol] ={1, 2, . . . , | [symbol] |} denotes the set of all candidate sites for facilities, rε [symbol] ₊ denotes the reachability radius, [symbol] denotes the set of all locations of interest to be covered, for each candidate site iε [symbol] , dᵢε [symbol] ₊ is the demand for service at i, and Sᵢ^{r}⊂ [symbol] is the set of locations of interest that would be covered if a facility were to be placed at i.

Let [symbol] ={1, 2, . . . , | [symbol] |} denote the set of private providers for facilities. For each private provider jε [symbol] , Bⱼε [symbol] ₊ is the total budget available, cᵢⱼε [symbol] ₊ is the subsidy that the private provider specifies they need at site iε [symbol] , and pᵢⱼε [symbol] ₊ is the cost to the private provider of building a facility at site iε [symbol] , after taking into account the subsidy cᵢⱼ.

[symbol] = [symbol] ∪{0} denotes the set of participants after adding the government agency to the set of providers. Bε [symbol] ₊ denotes the total budget available to the government agency, and cᵢ₀=cᵢ is the government agency's subsidy specification for site iε [symbol] . For each site iε [symbol] and each participant jεB, the outcome xᵢⱼε{0,1} denotes whether participant j “won” site i.

Given a set of prices, budgets and subsidy specifications from the participants, the outcome is determined by the following optimization problem:

$${max}_{\{ {x}_{ij} \text{:} i ∈ ℒ , j ∈ ℬ \}} {\sum }_{i ∈ ℒ} {d}_{i} {\sum }_{j ∈ ℬ} {x}_{ij} \\ {\sum }_{i ∈ ℒ} {\sum }_{j ∈ ℬ} {c}_{ij} {x}_{ij} \leq B \\ {\sum }_{i ∈ ℒ} {p}_{ij} {x}_{ij} \leq {B}_{j} ∀ j ∈ 𝒫 \\ {\sum }_{j ∈ ℬ} {x}_{ij} \leq 1 ∀ i ∈ ℒ \\ {\sum }_{k : 𝓁 ∈ {S}_{k}^{r}} {\sum }_{j ∈ ℬ} {x}_{kj} \geq 1 ∀ 𝓁 ∈ 𝒥 \qquad ( 10 )$$

The methods presented above can be extended to this scenario as well. More specifically, the IPAC heuristic presented above can be extended by: i) replacing calls to KNAPSACK( ) with calls to MULTIKNAPSACK( ) a method that solves the multi-dimensional knapsack problem; ii) incorporating the multiple knapsack costs of an item into the value function used in RANK( ); and iii) within each iteration, reducing multiple knapsack budgets and making sure that items are removed until all reduced budget constraints are satisfied.

Application to Placement of EV Charging Stations

As discussed above, one exemplary application that motivated development of the method and apparatus disclosed herein is the placement of charging stations for electric vehicles. The paragraphs that follow describe a specific use case pertaining to this application in more detail, and present experimental results.

Use Case

A use case for the system and methods for facility location described above is presented below. In the use case, a central planner (e.g., a government agency) can decide how best to use the available budget to select candidate sites for the deployment of electric vehicle charging stations with the goal of improving infrastructure by maximizing the demand satisfied while ensuring accessibility to a charging station from key locations of interest across a geographic region as well as bounded mean waiting times at charging stations.

Identifying Candidate Sites and Locations of Interest

The agency first identifies potential locations that span the geographic region of interest where charging stations could be installed. Locations that could be considered include parking lots, gas stations, mass transit connection points, etc. These potential locations constitute the set of candidate sites. Next, the agency identifies a set of locations of interest which must be covered after the deployment. In other words, there must be at least one charging station that is a short driving distance from each location. The locations of interest could include the candidate sites for charging stations, popular points of interest, or, if the aim is to completely cover a geographic region, all grid points in the region with a suitable grid size.

Estimating Demand and Charging Station Cost at Each Candidate Site

The agency estimates the average demand (in units of kW) at each candidate site using any suitable demand prediction model. In order to determine the costs of building charging stations at the candidate sites, the agency first estimates the per unit land value at each candidate site (obtained either from available public records and real estate market indicators, or some other estimation procedure), which is then used as a proxy for the per unit land cost. The size of the charging station depends on the number of charging spots to be provisioned at the charging station, which in turn is determined using the queuing model described above.

Before using this procedure, the agency gathers the following four pieces of information: i) an estimated peak demand (in units of kW) at the candidate site (obtained by running any suitable demand prediction model); ii) an average energy requirement (in units of kWh) of an electric vehicle that needs charging, (obtained from available charging data at existing charging locations); iii) an effective charging rate (in units of kW, obtained from a technical specification of a type of charging spot being installed, e.g., Level 1, Level 2, etc.); and iv) a desired SLA (upper bound) on the average waiting time (tᵢ, in units of hours) before an electric vehicle can start charging.

Then, the agency computes the peak arrival rate λᵢ of electric vehicles (number of vehicles per hour) to the charging station as the estimated peak demand divided by the average energy requirement, and the peak service rate μᵢ of electric vehicles (number of vehicles per hour) as the effective charging rate divided by the average energy requirement. The agency feeds in λᵢ, μᵢ, and tᵢ to the queuing model to obtain Nᵢ, the number of charging slots required at candidate site i. Multiplying Nᵢ by the average area required for a charging slot (obtained from technical specifications) gives the total area of the charging station, which the agency further multiplies by the estimated per unit land value to arrive at the total land cost for building the charging station. In addition to the land cost, there may be other costs such as infrastructure and construction costs, licensing and utility costs, etc. that can also be taken into consideration.

Obtaining the Selected Sites for Deployment

In obtaining the selected sites for deployment, the agency inputs into the optimization module the set of candidate sites, the set of locations of interest, the estimated demands and costs at the candidate sites, the available budget, and the desired trade-off between maximizing demand satisfied and minimizing the maximum driving distance to the nearest charging station. The optimization module outputs the recommended deployment consisting of the set of selected candidate sites where charging stations are to be installed, which the agency implements.

Experimental Results

The experiment mirrors the use case detailed above. Parking locations in Northeast UK are used for the candidate sites and for placing charging stations, as well as the locations of interest that need to be covered. This is equivalent to requiring that each candidate site must either have a charging station at the site, or one that is a short driving distance from it. Accordingly, the cover set Sᵢ^{r} for each candidate site i consists of the candidate sites that are within a distance of r from i. The charging station cost estimation was performed in the following three steps.

First, the per unit land cost at candidate sites was estimated as follows. Points of interest around a candidate site were observed to play vital roles in determining the land value at the site. The higher the number of points of interest, the higher the value of land. In addition, different types of facilities affect the land value differently, in proportion to their importance. Thus, the per unit land cost Lᵢ at candidate site iε [symbol] is generated using the formula:

$${L}_{i} = p + {\sum }_{j ∈ {P}_{i}^{δ}} \frac{{Score}_{j}}{dist ( i , j )}$$

where p=$4000 is the minimum per unit land cost across all the locations in Northeast UK (computed using known data), Pᵢ^{δ} is the set of points of interest that are within a radius δ=1 km from candidate site i, and Scoreⱼ is the score assigned to the point of interest j according to its type, as follows. Airports and railway stations have the highest scores of 800, whereas schools, restaurants and hospitals have a lower score of 300. The score of a point of interest is normalized by its distance dist(i,j) from the site.

Next, an infrastructure cost of constructing a Level 2 charging spot, Fᵢ, is taken from known data. For example, $1852 was used as the infrastructure cost.

Finally, a Level 2 charging rate of 6.4 kW and an upper bound of 5 minutes on the average waiting time are assumed and, for each candidate site, a minimum number Nᵢ of Level 2 charging spots are computed to ensure that the average waiting time during peak demand (taken as the estimated maximum hourly demand at the candidate site over two years) is less than 5 minutes.

The total cost cᵢ of constructing a charging station at candidate site iε [symbol] is then computed as cᵢ=Nᵢ(Lᵢ+Fᵢ). For both KNAPSACK( ) and WSETCOVER( ) methods (needed by IPAC), greedy approximation methods from Vazirani are chosen. The RANK( ) method described above is used.

Feasibility of IPAC

Since the IPAC method is heuristic, it may falsely deem an instance of the optimization problem presented using Equation (1) as infeasible, when in fact, feasible solutions exist. Thus, it is important to analyze the extent of this limitation. It is easy to observe that an instance is feasible using Equation (1) if, and only if, the available budget B is greater than or equal to the minimum required budget determined by solving the corresponding instance of the weighted set cover sub-problem using Equation (8). In the case of the IPAC method, it reduces to whether the available budget B is greater than or equal to the minimum required budget required as determined by WSETCOVER( ) for which the greedy approximation method for weighted set cover described in Vazirani is employed.

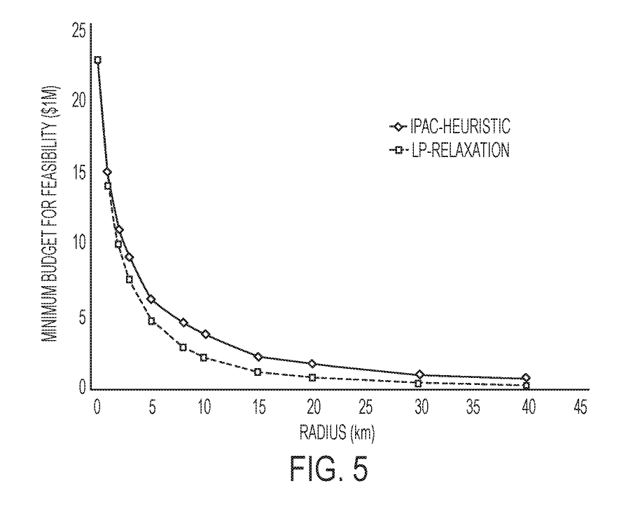

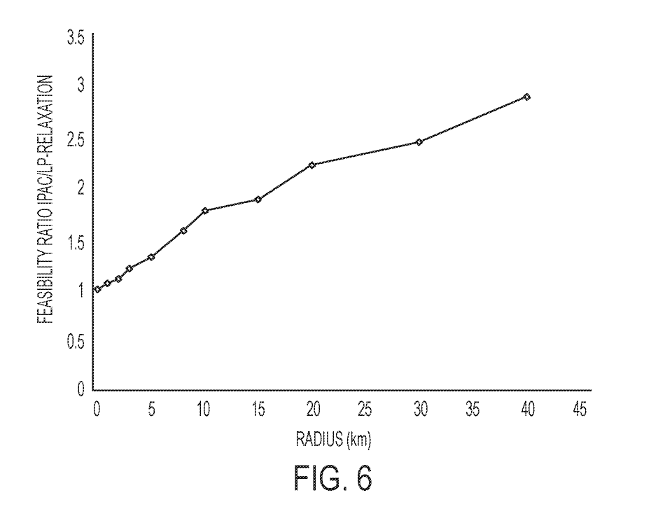

Therefore, given an instance using Equation (1), look at the corresponding weighted set cover sub-problem using Equation (8), and compare its solutions (the minimum required budgets) as obtained by i) using the greedy approximation method in Vazirani and ii) directly solving its relaxed LP. Values of r (in units of km) from the set {1; 2; 3; 5; 8; 10; 15; 20; 30; 40} were used in the experiment to generate the instances. The results are plotted in FIGS. 5 and 6.

Note that since the LP relaxation allows for fractional allocations, the corresponding solution is only a lower bound on the actual minimum budget required for feasibility. Hence, the actual feasibility gap would likely be smaller than that depicted in FIG. 5. Also, from FIG. 6, note that for the instances of interest, where r is smaller, the feasibility ratios are also smaller.

Performance of IPAC

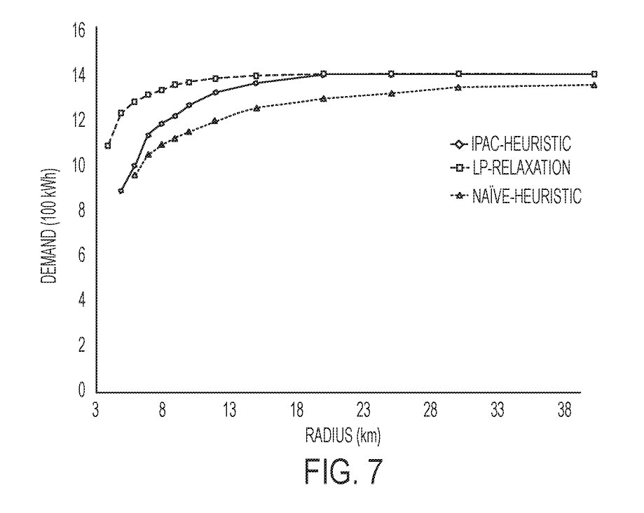

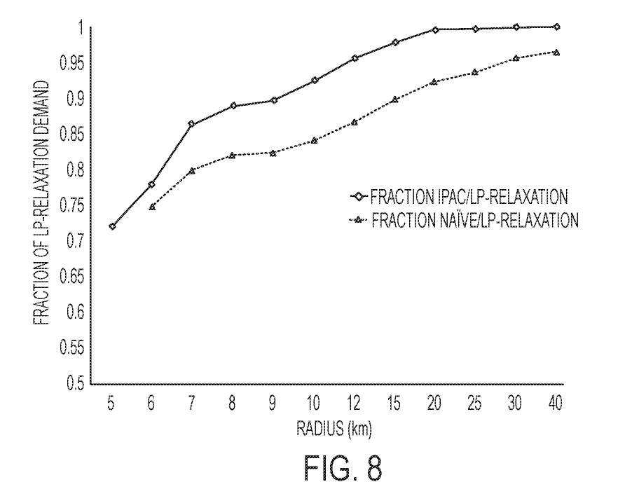

To evaluate the performance of the IPAC heuristic when feasible solutions exist, compare it with a naive heuristic and the solution to the LP relaxation of the optimization problem using Equation (1), for a budget of B=$6M. The naive heuristic first solves the covering problem using WSETCOVER( ) and then invokes KNAPSACK( ) on the remaining budget to add unselected candidate sites for satisfying more demand. The LP relaxation solution gives an upper bound on the actual (integer LP) optimization problem using Equation (1). The results are plotted in FIGS. 7 and 8.

The number of pairwise distances between candidate sites is prohibitively large for the experiment; so, in order to evaluate the performance of the IPAC module, values of r (in units of km) from the set {5.1, 6, 7; 8, 9, 10, 12, 15, 20, 25, 30, 40} are used. Even though R^{max}=297 km, as it can be seen from FIG. 7, the demand satisfied sufficiently converges within r=40 km, and further increase of r would only increase the demand satisfied negligibly, if at all.

As the reachability radius is increased, the set of allocations that satisfy the covering constraints steadily gets larger, until, for a large enough radius, any allocation would satisfy the covering constraints, reducing the optimization to a pure packing problem. Since the feasibility set only gets larger with r, the demand covered also increases, as explained above in more detail. The graphs validate this expected behavior. In addition, it is observed that the demand captured by the IPAC heuristic is far closer to that of LP relaxation than that captured by the naive heuristic. In particular, from FIG. 8, one can see that when r=9 km, the IPAC heuristic already captures almost 90% of the LP relaxation demand.

Optimizing for Reachability

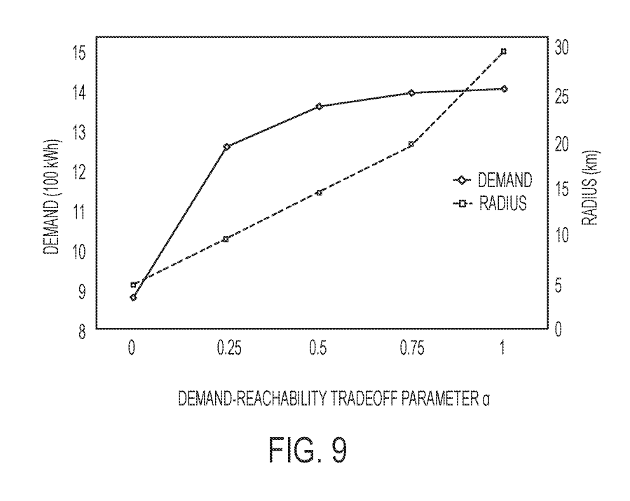

Finally, to illustrate the trade-off between minimizing the reachability radius and maximizing the demand, calculate the optimal demand and reachability radius obtained for the optimization problem using Equation (4), for values of the demand-reachability trade-off parameter αε{0, 0.25, 0.5, 0.75, 1}. The results are plotted in FIG. 9.

Other Applications: Placement of Bus Stop Shelters, Parking Lots, and Healthcare Kiosks

The various embodiments of the facility location system model and method presented herein are also applicable to other incremental placement problems where the aim is to maximize satisfied demand with constraints on budget and coverage/reachability. Consider a case where a public or a private agency wants to initiate or expand a network of bus stop shelters, parking lots or healthcare kiosks (such as HealthSpot). In each of these cases, there are i) multiple candidate sites (for facilities) with their predicted demand, ii) a budget for the deployment which is either released all at once or over a period of time, and iii) a set of locations of interest (spanning a geographical region) to be covered, so that there is a facility within a short walking/driving distance of each location of interest. Although the core facility location model and method presented herein can be directly applied for these use cases, the demand prediction method and the sizing of the facility at a candidate site (which in turn determines the cost of deploying the facility at that site) will depend on the specific use case. Demand prediction methods for bus stops and parking lots have been studied in Chen et al. Sizing of a facility depends on its arrival and service time distributions, and, as illustrated for the EV charging station placement use case, queuing analysis can be used to find the size (e.g., number of seats at a bus stop shelter, parking slots, or individual booths at the kiosk) based on an upper bound on mean waiting time (applicable for parking lots and healthcare kiosks), or mean queue length (applicable for the number of seats at a bus stop shelter).

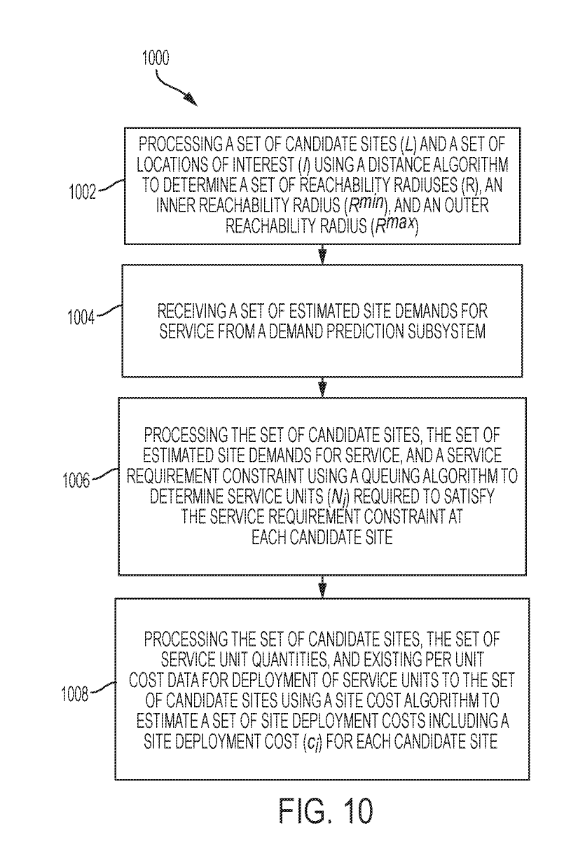

With reference to FIG. 10, an exemplary embodiment of a process 1000 for planning deployment of facilities begins at 1002 where a set of candidate sites ( [symbol] ) and a set of locations of interest ( [symbol] ) are processed using a distance algorithm to determine a set of reachability radiuses ( [symbol] ), an inner reachability radius (R^{min}), and an outer reachability radius (R^{max}) Each candidate site (i) is a member of the set of candidate sites. Each location of interest (l) is a member of the set of locations of interest. Each reachability radius (r) is a member of the set of reachability radiuses. Next, a set of estimated site demands for service are received from a demand prediction subsystem (1004). The set of estimated site demands for service includes an estimated site demand for service (dᵢ) for each candidate site of the set of candidate sites. At 1006, the set of candidate sites, the set of estimated site demands for service, and a service requirement constraint are processed using a queuing algorithm to determine service units (Nᵢ) required to satisfy the service requirement constraint at each candidate site. The determined service units for each candidate site form a set of service unit quantities. Next, the set of candidate sites, the set of service unit quantities, and existing per unit cost data for deployment of service units to the set of candidate sites are processed using a site cost algorithm to estimate a set of site deployment costs including a site deployment cost (cᵢ) for each candidate site (1008). Each site deployment cost represents costs to obtain the corresponding candidate site and to setup the service units at the corresponding candidate site.

In another embodiment of the process 1000, the set of reachability radiuses relate to each location of interest such that each reachability radius is a function of distance from the corresponding location of interest. The inner reachability radius is determined such that any radius less than the inner reachability radius would leave at least one location of interest from which it would be unable to reach at least one candidate site. The outer reachability radius is determined such that no distance from any location of interest to any candidate site is greater than the outer reachability radius. The inner reachability radius, outer reachability radius, and each reachability radius therebetween form a reachability radius range.

In yet another embodiment of the process 1000, the service units comprise electric vehicle charging stations, bus stop shelters, parking lots, healthcare kiosks, or any other suitable type of facilities.

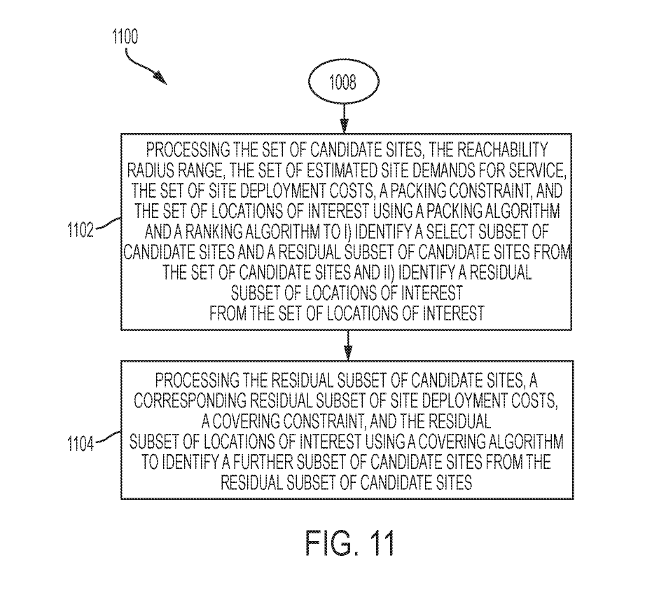

With reference to FIGS. 10 and 11, yet another exemplary embodiment of a process 1100 for planning deployment of facilities includes the process 1000 of FIG. 10 and continues from 1008 to 1102 where the set of candidate sites, the reachability radius range, the set of estimated site demands for service, the set of site deployment costs, a packing constraint, and the set of locations of interest are processed using a packing algorithm and a ranking algorithm to identify a select subset of candidate sites and a residual subset of candidate sites from the set of candidate sites. The candidate sites selected for the select subset of candidate sites maximize satisfied demand for service at a select reachability radius within the reachability radius range while satisfying a budget constraint. Remaining candidate sites from the set of candidate sites constitute the residual subset of candidate sites. The packing and ranking algorithms also identify a residual subset of locations of interest from the set of locations of interest. Locations of interest from which it would be unable to reach the select subset of candidate sites for the select reachability radius are grouped in the residual subset of locations of interest. A demand deployment cost is determined based on the corresponding site deployment costs for the select subset of candidate sites at the select reachability radius. A remainder budget is determined based on a difference between the budget constraint and the demand deployment cost. Next, the residual subset of candidate sites, a corresponding residual subset of site deployment costs, a covering constraint, and the residual subset of locations of interest are processed using a covering algorithm to identify a further subset of candidate sites from the residual subset of candidate sites (1104). The candidate sites selected for the further subset of candidate sites permit the residual subset of locations of interest to reach services for the select reachability radius. A covering deployment cost is determined based on the corresponding site deployment costs for the further subset of candidate sites at the select reachability radius.

If the covering deployment cost is greater than the agency budget constraint, there is no feasible facility deployment option for the select reachability radius.

If the covering deployment cost is greater than the reminder budget, the process 1100 continues by using a priority ranking associated with satisfaction of the packing, covering, and budget constraints to move a candidate site with least priority from the select subset of candidate sites to the residual subset of candidate sites. This creates a new select subset of candidate sites and a new residual subset of candidate sites. A new residual subset of locations of interest is identified from the set of locations of interest. Locations of interest from which it would be unable to reach the new select subset of candidate sites for the select reachability radius are grouped in the new residual subset of locations of interest. A new demand deployment cost is determined based on the corresponding site deployment costs for the new select subset of candidate sites at the select reachability radius. A new remainder budget is determined based on a difference between the budget constraint and the new demand deployment cost. Then, the processing using the covering algorithm and the new residual subset of candidate sites, a corresponding new residual subset of site deployment costs, the covering constraint, and the new residual subset of locations of interest is repeated.

If the covering deployment cost equals the remainder budget, the select and further subsets of candidate sites and the service units associated with the corresponding candidate sites form an optimized facility deployment option for the select reachability radius.

If the covering deployment cost is less than the remainder budget, the process 1100 continues by determining a remainder demand budget based on a difference between the budget constraint and a sum of the demand and covering deployment costs. A remainder subset of candidate sites is identified based on a difference between the set of candidate sites and a combination of the select and further subsets of candidate sites. Then, the processing using the packing algorithm is repeated to identify a supplemental subset of candidate sites with the budget constraint adjusted to be the same as the remainder demand budget. The select, further, and supplemental subsets of candidate sites and the service units associated with the corresponding candidate sites form the optimized facility deployment option for the select reachability radius.

In another embodiment, the process 1100 also includes using the packing, ranking, and covering algorithms in the same manner for each reachability radius in the reachability radius range.

In a further embodiment, the process 1100 also includes processing a portion of the set of estimated site demands for service corresponding to the select, further, and supplemental subsets of candidate sites for each reachability radius associated with a feasible deployment option, the inner reachability radius, the outer reachability radius, and a weighting factor using a demand-reachability trade-off algorithm to identify an optimized facility deployment option among the feasible deployment option. The weighting factor ranges between a first value favoring maximizing the satisfied demand for service with limited or no concern for minimizing the reachability radius and a second value favoring minimizing the reachability radius with limited or no concern for maximizing the satisfied demand for service.

In another further embodiment, the process 1100 also includes processing the candidate sites, reachability radius, service unit quantities, and site deployment costs associated with the optimized facility deployment option using a report processing algorithm to generate a facility deployment plan that satisfies the service requirement, packing, covering, and budget constraints.

With reference to FIGS. 10, 11, 12A, and 12B, progressive releases of portions of an overall budget lead to incremental deployment of facilities over an extended time that include an initial time period for which the optimized deployment option and at least one subsequent time period. Each subsequent time period resulting in an optimized incremental deployment option based at least in part on using the queuing, site cost, packing, ranking, and covering algorithms with a revised set of estimated site demands for service, revised existing per unit cost data for deployment of service units to candidate sites, and a supplemental budget constraint.

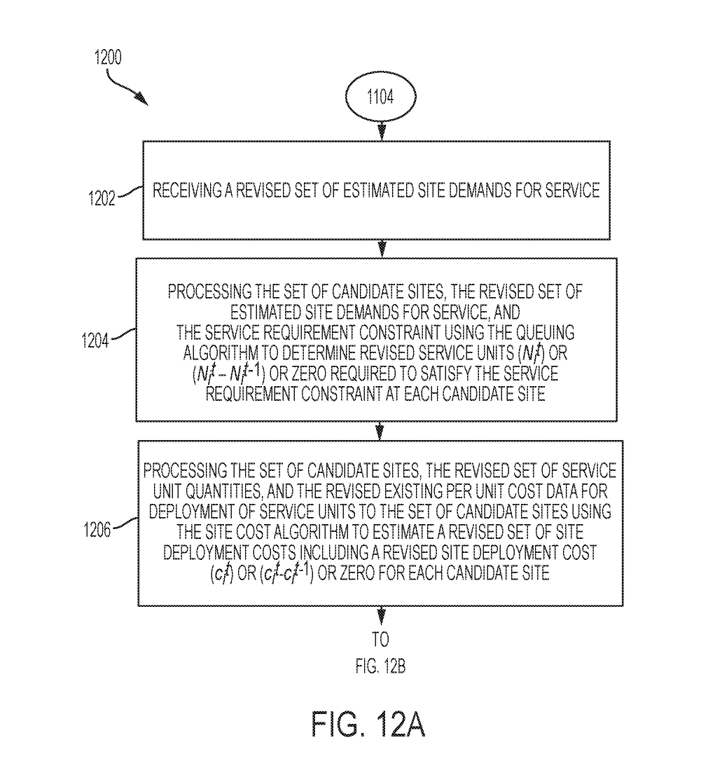

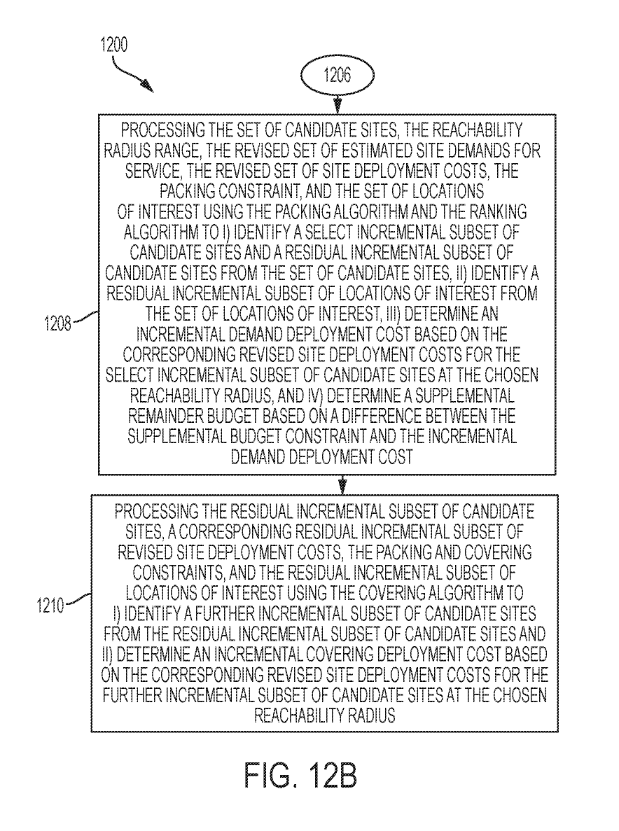

Still yet another exemplary embodiment of a process 1200 for planning deployment of facilities includes the processes 1000, 1100 of FIGS. 10 and 11 and continues from 1104 to 1202 of FIG. 12A where a revised set of estimated site demands for service is received from a demand prediction subsystem. The revised set of estimated site demands for service includes a revised estimated demand for service (dᵢ^{t}) or (dᵢ^{t}−dᵢ^{t-1}) or zero for the each candidate site of the set of candidate sites. The revised estimated site demand for candidate sites for which service units were not previously deployed is (dᵢ^{t}) and the revised estimated site demand for candidate sites with service units previously deployed is (dᵢ^{t}−dᵢ^{t-1}) or zero, whichever is larger. Next, the set of candidate sites, the revised set of estimated site demands for service, and the service requirement constraint are processed using the queuing algorithm to determine revised service units (Nᵢ^{t}) or (Nᵢ^{t}−Nᵢ^{t-1}) or zero required to satisfy the service requirement constraint at each candidate site (1204). The revised service units for candidate sites for which service units were not previously deployed are (Nᵢ^{t}) and the revised service units for candidates with service units previously deployed are (Nᵢ^{t}−Nᵢ^{t-1}) or zero, whichever is larger, and represent supplemental service units. The revised determined service units for each candidate site form a revised set of service unit quantities. At 1206, the set of candidate sites, the revised set of service unit quantities, and the revised existing per unit cost data for deployment of service units to the set of candidate sites are processed using the site cost algorithm to estimate a revised set of site deployment costs including a revised site deployment cost (cᵢ^{t}) or (cᵢ^{t}−cᵢ^{t-1}) or zero for each candidate site. The revised site deployment costs for candidate sites for which service units were not previously deployed are (cᵢ^{t}) and represent costs to obtain the corresponding candidate site and to setup the service units at the corresponding candidate site. The revised site deployment costs for candidate sites with service units previously deployed are (cᵢ^{t}−cᵢ^{t-1}) or zero, whichever is larger, and represent costs to setup the supplemental service units at the corresponding candidate site.

Next, with reference to FIG. 12B, the set of candidate sites, the reachability radius range, the revised set of estimated site demands for service, the revised set of site deployment costs, the packing constraint, and the set of locations of interest are processing using the packing algorithm and the ranking algorithm to identify a select incremental subset of candidate sites and a residual incremental subset of candidate sites from the set of candidate sites (1208). The candidate sites selected for the select incremental subset of candidate sites maximize satisfied demand for service at a select reachability radius within the reachability radius range while satisfying a supplemental budget constraint. The remaining candidate sites from the set of candidate sites constitute the residual incremental subset of candidate sites. The packing and ranking algorithms also identify a residual incremental subset of locations of interest from the set of locations of interest. Locations of interest from which it would be unable to reach the select incremental subset of candidate sites for the select reachability radius are grouped in the residual incremental subset of locations of interest. The packing and ranking algorithms also determine an incremental demand deployment cost based on the corresponding revised site deployment costs for the select incremental subset of candidate sites at the select reachability radius. The packing and ranking algorithms also determine a supplemental remainder budget based on a difference between the supplemental budget constraint and the incremental demand deployment cost. At 1210, the residual incremental subset of candidate sites, a corresponding residual incremental subset of revised site deployment costs, the packing and covering constraints, and the residual incremental subset of locations of interest are processed using the covering algorithm to identify a further incremental subset of candidate sites from the residual incremental subset of candidate sites. The candidate sites selected for the further incremental subset of candidate sites permit the residual incremental subset of locations of interest to reach services for the select reachability radius. The covering algorithm also determines an incremental covering deployment cost based on the corresponding revised site deployment costs for the further incremental subset of candidate sites at the select reachability radius.

If the incremental covering deployment cost is greater than the supplemental budget constraint, there is no feasible facility deployment option for the select reachability radius. The process 1200 continues by selecting a different reachability radius from the reachability radius range and repeating the processing using the packing, ranking, and covering algorithms for the different reachability radius.

If the incremental covering deployment cost is greater than the supplemental remainder budget, the process 1200 continues by using a priority ranking associated with satisfaction of the packing, covering, and supplemental budget constraints to move a candidate site with least priority from the select incremental subset of candidate sites to the residual incremental subset of candidate sites. This creates a new select incremental subset of candidate sites and a new residual incremental subset of candidate sites. A new residual incremental subset of locations of interest is identified from the set of locations of interest. Locations of interest from which it would be unable to reach the new select incremental subset of candidate sites for the select reachability radius are grouped in the new residual incremental subset of locations of interest. A new incremental demand deployment cost is determined based on the corresponding revised site deployment costs for the new select incremental subset of candidate sites at the select reachability radius. A new supplemental remainder budget is determined based on a difference between the supplemental budget constraint and the new incremental demand deployment cost. The processing using the covering algorithm and the new residual incremental subset of candidate sites, a corresponding new residual incremental subset of site deployment costs, the covering constraint, and the new residual incremental subset of locations of interest is repeated.

If the incremental covering deployment cost equals the supplemental remainder budget, the select and further incremental subsets of candidate sites and the supplemental service units associated with the corresponding candidate sites form an optimized incremental facility deployment option for the select reachability radius.

If the incremental covering deployment cost is less than the supplemental remainder budget, the process 1400 also includes determining a supplemental remainder demand budget based on a difference between the supplemental budget constraint and a sum of the incremental demand and covering deployment costs. A remainder incremental subset of candidate sites is identified based on a difference between the set of candidate sites and a combination of previous select and further subsets of candidate sites and the select and further incremental subsets of candidate sites. The processing using the packing algorithm is repeated to identify a supplemental incremental subset of candidate sites with the supplemental budget constraint adjusted to be the same as the supplemental remainder demand budget. The select, further, and supplemental incremental subsets of candidate sites and the supplemental service units associated with the corresponding candidate sites form the optimized incremental facility deployment option for the select reachability radius.

In yet another embodiment, the process 1200 also includes processing the candidate sites, reachability radius, service unit quantities, and site deployment costs associated with the optimized incremental facility deployment option using the report processing algorithm to generate an incremental facility deployment plan that satisfies the service requirement, packing, covering, and supplementary budget constraints.

With reference to FIGS. 10, 11, and 13 the set of site deployment costs is a set of baseline subsidy bids for site deployment costs at each reachability radius in the reachability radius range by an authoritative agency that controls a competition among the private providers for subsidies from the authoritative agency for the deployment of the corresponding service units at each candidate site for the corresponding reachability radius range. The authoritative agency determines an optimized deployment option that maximizes satisfaction of demand for service and ensures access to reach service within an agency budget constraint and budget constraints from the multiple providers.

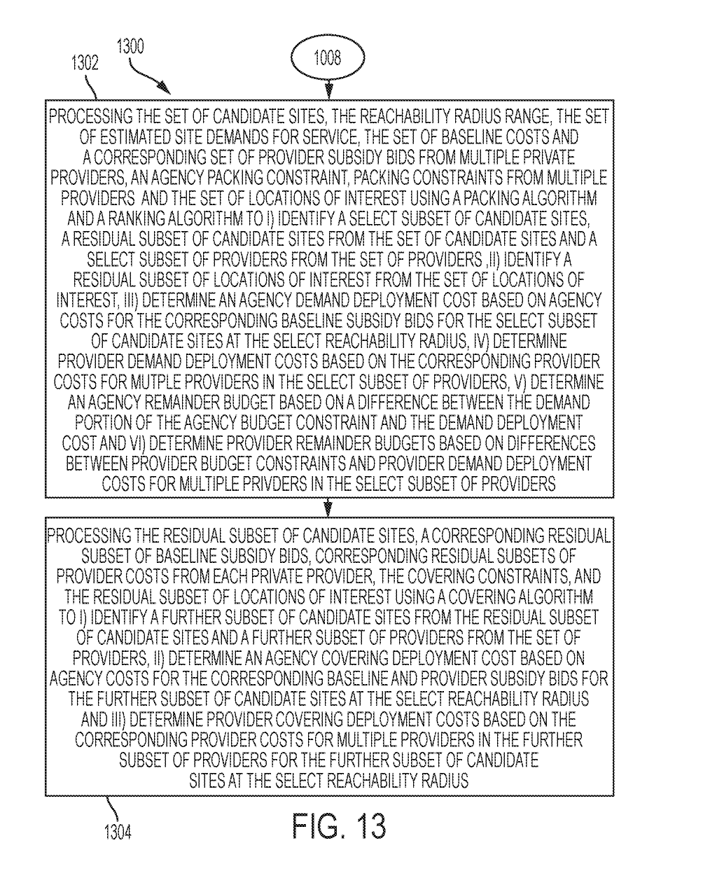

With reference to FIGS. 10 and 13, another exemplary embodiment of a process 1300 for planning deployment of facilities includes the process 1000 of FIG. 10 and continues from 1008 to 1302 where the set of candidate sites, the reachability radius range, the set of estimated site demands for service, the set of baseline subsidy bids, a corresponding set of provider costs from multiple private providers, an agency packing constraint, packing constraints from multiple providers, and the set of locations of interest are processed using a packing algorithm and a ranking algorithm to identify a select subset of candidate sites, a residual subset of candidate sites from the set of candidate sites, and a select subset of providers from the set of providers. The candidate sites selected for the select subset of candidate sites and the corresponding baseline subsidy bids from the select subset of providers maximize satisfied demand for service at a select reachability radius within the reachability radius range while satisfying the agency budget constraint and budget constraints from the multiple providers. The remaining candidate sites from the set of candidate sites constitute the residual subset of candidate sites. The packing and ranking algorithms also identify a residual subset of locations of interest from the set of locations of interest. Locations of interest from which it would be unable to reach the select subset of candidate sites for the select reachability radius are grouped in the residual subset of locations of interest. The packing and ranking algorithms also determine an agency demand deployment cost based on agency costs for the corresponding baseline subsidy bids for the select subset of candidate sites at the select reachability radius. The packing and ranking algorithms also determine provider demand deployment costs based on the provider costs for multiple providers in the select subset of providers. The packing and ranking algorithms also determine an agency remainder budget based on a difference between the agency budget constraint and the agency demand deployment cost. The packing and ranking algorithms also determine provider remainder budgets based on differences between provider budget constraints and provider demand deployment costs for multiple providers in the select subset of providers. Next, the residual subset of candidate sites, a corresponding residual subset of baseline subsidy bids, corresponding residual subsets of provider subsidy costs from each private provider, the covering constraints, and the residual subset of locations of interest are processed using a covering algorithm to identify a further subset of candidate sites from the residual subset of candidate sites and a further subset of providers from the set of providers (1304). The candidate sites selected for the further subset of candidate sites permit the residual subset of locations of interest to reach services for the select reachability radius. The covering algorithm also determines an agency covering deployment cost based on agency costs for the corresponding baseline and provider subsidy bids for the further subset of candidate sites at the select reachability radius. The covering algorithm also determines provider covering deployment costs based on the corresponding provider costs for multiple providers in the further subset of providers for the further subset of candidate sites at the select reachability radius.

If the agency covering deployment cost is greater than the agency budget constraint or if at least one of the provider covering deployment costs is greater than the corresponding provider budget constraint, there is no feasible facility deployment option for the select reachability radius and the process 1300 continues by selecting an alternate reachability radius from the reachability radius range and repeating the processing using the packing, ranking, and covering algorithms for the alternate reachability radius.

If the agency covering deployment cost is greater than the agency remainder budget or if at least one of the provider covering deployment costs is greater than the corresponding provider remainder budget, the process 1300 continues by using a priority ranking associated with satisfaction of the packing, covering, and budget constraints to move a candidate site with least priority from the select subset of candidate sites to the residual subset of candidate sites and remove the corresponding provider from the select subset of providers. This creates a new select subset of candidate sites and associated new baseline subsidy bids, a new residual subset of candidate sites, and a new select subset of providers. A new residual subset of locations of interest is identified from the set of locations of interest. Locations of interest from which it would be unable to reach the new select subset of candidate sites for the select reachability radius are grouped in the new residual subset of locations of interest. A new agency demand deployment cost is determined for the new select subset of candidate sites at the select reachability radius based on agency costs for the corresponding new baseline subsidy bids. Provider demand deployment costs are determined for the new select subset of candidate sites at the select reachability radius based on the corresponding provider costs for multiple providers in the new select subset of providers. A new agency remainder budget is determined based on a difference between the agency budget constraint and the new agency demand deployment cost, and new provider remainder budgets based on differences between provider budget constraints and new provider demand deployment costs for multiple providers in the new select subset of providers. The processing using the covering algorithm and the new residual subset of candidate sites, a corresponding new residual subset of baseline subsidy bids, corresponding new residual subset of provider costs from each private provider, the covering constraints, and the new residual subset of locations of interest is repeated.

If the agency covering deployment cost equals the agency remainder budget or if at least one of the provider covering deployment costs equals the corresponding provider remainder budget, the select and further subsets of candidate sites, the corresponding select and further subsets of providers, and the service units associated with the corresponding candidate sites form an optimized facility deployment option for the select reachability radius.

If the agency covering deployment cost is less than the agency remainder budget and all of the provider covering deployment costs are less than the corresponding provider remainder budgets, the process 1300 continues by determining a remainder demand budget based on a difference between the agency budget constraint and a sum of the agency demand and covering deployment costs. Provider remainder budgets are determined based on differences between provider budget constraints and provider demand deployment costs for multiple providers in the select and further subsets of providers. A remainder subset of candidate sites is identified based on a difference between the set of candidate sites and a combination of the select and further subsets of candidate sites. The processing using the packing algorithm is repeated to identify a supplemental subset of candidate sites and a corresponding supplemental subset of providers with the agency budget constraint adjusted to be the same as the agency remainder demand budget and the provider budget constraints adjusted to be the same as the provider remainder demand budgets. The select, further, and supplemental subsets of candidate sites, the corresponding select, further, and supplemental subsets of providers, and the service units associated with the corresponding candidate sites form the optimized facility deployment option for the select reachability radius.

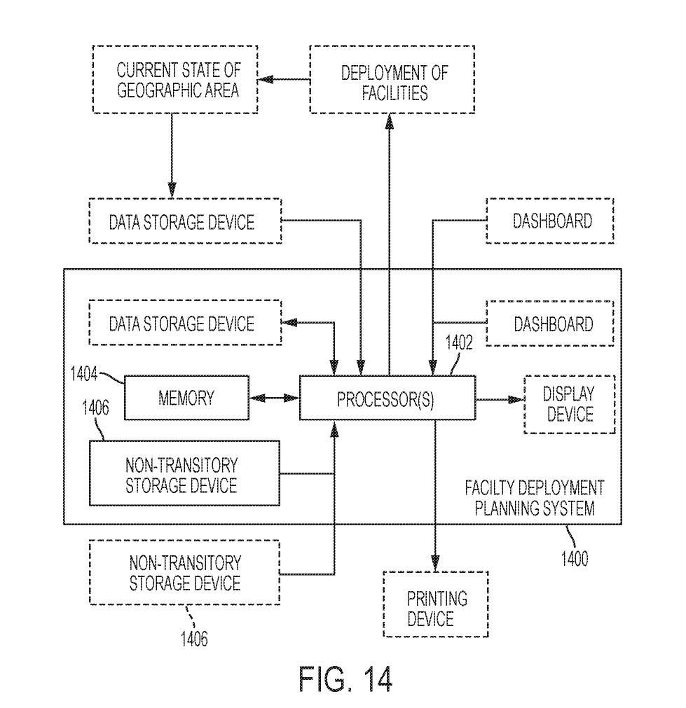

With reference to FIG. 14, an exemplary embodiment of a facility deployment planning system 1400 includes at least one processor 1402, associated memory 1404, and a non-transitory storage device 1406. The non-transitory storage device 1406 configured to store program instructions that, when executed by the at least one processor 1402, cause the facility deployment planning system 1400 to perform a method of planning for deployment of facilities. The at least one processor 1402 is configured to process a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}). Each candidate site (i) is a member of the set of candidate sites. Each location of interest (l) is a member of the set of locations of interest. Each reachability radius (r) is a member of the set of reachability radiuses. The at least one processor 1402 is configured to receive a set of estimated site demands for service from a demand prediction subsystem. The set of estimated site demands for service includes an estimated site demand for service (dᵢ) for each candidate site of the set of candidate sites. The at least one processor 1402 is configured to process the set of candidate sites, the set of estimated site demands for service, and a service requirement constraint using a queuing algorithm to determine service units (Nᵢ) required to satisfy the service requirement constraint at each candidate site. The determined service units for each candidate site at each reachability radius form a set of service unit quantities. The at least one processor 1402 is configured to process the set of candidate sites, the set of service unit quantities, and existing per unit cost data for deployment of service units to the set of candidate sites using a site cost algorithm to estimate a set of site deployment costs including a site deployment cost (cᵢ) for each candidate site. Each site deployment cost represents costs to obtain the corresponding candidate site and to setup the service units at the corresponding candidate site.

In another embodiment of the facility deployment planning system 1400, the set of reachability radiuses relate to each location of interest such that each reachability radius is a function of distance from the corresponding location of interest. The inner reachability radius is determined such that any radius less than the inner reachability radius would leave at least one location of interest from which it would be unable to reach at least one candidate site. The outer reachability radius is determined such that no distance from any location of interest to any candidate site is greater than the outer reachability radius. The inner reachability radius, outer reachability radius, and each reachability radius therebetween form a reachability radius range.

In yet another embodiment of the facility deployment planning system 1400, the service units includes electric vehicle charging stations, bus stop shelters, parking lots, healthcare kiosks, or any suitable type of facilities.

In still yet another embodiment of the facility deployment planning system 1400, the at least one processor 1402 is configured to process the set of candidate sites, the reachability radius range, the set of estimated site demands for service, the set of site deployment costs, a packing constraint, and the set of locations of interest using a packing algorithm and a ranking algorithm to identify a select subset of candidate sites and a residual subset of candidate sites from the set of candidate sites. The candidate sites selected for the select subset of candidate sites maximize satisfied demand for service at a select reachability radius within the reachability radius range while satisfying a budget constraint. Remaining candidate sites from the set of candidate sites constitute the residual subset of candidate sites. The packing and ranking algorithms also identify a residual subset of locations of interest from the set of locations of interest. Locations of interest from which it would be unable to reach the select subset of candidate sites for the select reachability radius are grouped in the residual subset of locations of interest. A demand deployment cost is determined based on the corresponding site deployment costs for the select subset of candidate sites at the select reachability radius. A remainder budget is determined based on a difference between the budget constraint and the demand deployment cost. The at least one processor 1402 is configured to process the residual subset of candidate sites, a corresponding residual subset of site deployment costs, a covering constraint, and the residual subset of locations of interest using a covering algorithm to identify a further subset of candidate sites from the residual subset of candidate sites. The candidate sites selected for the further subset of candidate sites permit the residual subset of locations of interest to reach services for the select reachability radius. The covering algorithm is also used to determine a covering deployment cost based on the corresponding site deployment costs for the further subset of candidate sites at the select reachability radius.

If the covering deployment cost is greater than the agency budget constraint, there is no feasible facility deployment option for the select reachability radius.

If the covering deployment cost is greater than the reminder budget, the at least one processor is configured to use a priority ranking associated with satisfaction of the packing, covering, and budget constraints to move a candidate site with least priority from the select subset of candidate sites to the residual subset of candidate sites, thereby creating a new select subset of candidate sites and a new residual subset of candidate sites. The at least one processor is configured to identify a new residual subset of locations of interest from the set of locations of interest. Locations of interest from which it would be unable to reach the new select subset of candidate sites for the select reachability radius are grouped in the new residual subset of locations of interest. The at least one processor is configured to determine a new demand deployment cost based on the corresponding site deployment costs for the new select subset of candidate sites at the select reachability radius. The at least one processor is configured to determine a new remainder budget based on a difference between the budget constraint and the new demand deployment cost. The at least one processor is configured to repeat the processing using the covering algorithm and the new residual subset of candidate sites, a corresponding new residual subset of site deployment costs, the covering constraint, and the new residual subset of locations of interest;

If the covering deployment cost equals the remainder budget, the select and further subsets of candidate sites and the service units associated with the corresponding candidate sites form an optimized facility deployment option for the select reachability radius;

If the covering deployment cost is less than the remainder budget, the at least one processor is configured to continue by determining a remainder demand budget based on a difference between the budget constraint and a sum of the demand and covering deployment costs. The at least one processor is configured to identify a remainder subset of candidate sites based on a difference between the set of candidate sites and a combination of the select and further subsets of candidate sites. The at least one processor is configured to repeat the processing using the packing algorithm to identify a supplemental subset of candidate sites with the budget constraint adjusted to be the same as the remainder demand budget. The select, further, and supplemental subsets of candidate sites and the service units associated with the corresponding candidate sites form the optimized facility deployment option for the select reachability radius.

In a further embodiment, the at least one processor 1402 is configured to use the packing and ranking algorithms in the same manner for each reachability radius in the reachability radius range. The at least one processor 1402 is configured to use the covering algorithm in the same manner for each reachability radius in the reachability radius range. If at least one of the demand or covering portions of the budget constraint is not satisfied for the corresponding reachability radius, there is no feasible facility deployment option for the corresponding reachability radius. Otherwise, the select and further subsets of candidate sites and the service units associated with the corresponding candidate sites form feasible facility deployment options for the corresponding reachability radius and the feasible facility deployment option with a lowest reachability radius forms an optimized facility deployment option.

In a still further embodiment, the at least one processor 1402 is configured to process a portion of the set of estimated site demands for service corresponding to the select, further, and supplemental subsets of candidate sites for each reachability radius associated with a feasible deployment option, the inner reachability radius, the outer reachability radius, and a weighting factor using a demand-reachability trade-off algorithm to identify an optimized facility deployment option among the feasible deployment option. The weighting factor ranges between a first value favoring maximizing the satisfied demand for service with limited or no concern for minimizing the reachability radius and a second value favoring minimizing the reachability radius with limited or no concern for maximizing the satisfied demand for service.

In an even further embodiment, the at least one processor 1402 is configured to process the candidate sites, reachability radius, service unit quantities, and site deployment costs associated with the optimized facility deployment option using a report processing algorithm to generate a facility deployment plan that satisfies the service requirement, packing, covering, and budget constraints.

In another further embodiment, the facility deployment planning system 1400 is configured to operate in scenarios where progressive releases of portions of an overall budget lead to incremental deployment of facilities over an extended time that include an initial time period for which the optimized deployment option and at least one subsequent time period. Each subsequent time period resulting in an optimized incremental deployment option based at least in part on using the queuing, site cost, packing, ranking, and covering algorithms with a revised set of estimated site demands for service, revised existing per unit cost data for deployment of service units to candidate sites, and a supplemental budget constraint.

In an even further embodiment, the at least one processor 1402 is configured to receive a revised set of estimated site demands for service from a demand predictions subsystem. The revised set of estimated site demands for service includes a revised estimated site demand for service (dᵢ^{t}) or (dᵢ^{t}−dᵢ^{t-1}) or zero for each candidate site of the set of candidate sites. The revised estimated site demand for candidate sites for which service units were not previously deployed is (dᵢ^{t}) and the revised estimated site demand for candidate sites with service units previously deployed is (dᵢ^{t}−dᵢ^{t-1}) or zero, whichever is larger. The at least one processor 1402 is configured to process the set of candidate sites, the revised set of estimated site demands for service, and the service requirement constraint using the queuing algorithm to determine revised service units (Nᵢ^{t}) or (Nᵢ^{t}−Nᵢ^{t-1}) or zero required to satisfy the service requirement constraint at each candidate site. The revised service units for candidate sites for which service units were not previously deployed are (Nᵢ^{t}) and the revised service units for candidates with service units previously deployed are (Nᵢ^{t}−Nᵢ^{t-1}) or zero, whichever is larger, and represent supplemental service units. The revised determined service units for each candidate site form a revised set of service unit quantities. The at least one processor 1402 is configured to process the set of candidate sites, the revised set of service unit quantities, and the revised existing per unit cost data for deployment of service units to the set of candidate sites using the site cost algorithm to estimate a revised set of site deployment costs including a revised site deployment cost (cᵢ^{t}) or (cᵢ^{t}−cᵢ^{t-1}) or zero for each candidate site. The revised site deployment costs for candidate sites for which service units were not previously deployed are (cᵢ^{t}) and represent costs to obtain the corresponding candidate site and to setup the service units at the corresponding candidate site. The revised site deployment costs for candidate sites with service units previously deployed are (cᵢ^{t}−cᵢ^{t-1}) or zero, whichever is larger, and represent costs to setup the supplemental service units at the corresponding candidate site.

In a still even further embodiment, the at least one processor 1402 is configured to process the set of candidate sites, the reachability radius range, the revised set of estimated site demands for service, the revised set of site deployment costs, the packing constraint, and the set of locations of interest using the packing algorithm and the ranking algorithm to identify a select incremental subset of candidate sites and a residual incremental subset of candidate sites from the set of candidate sites. The candidate sites selected for the select incremental subset of candidate sites maximize satisfied demand for service at a select reachability radius within the reachability radius range while satisfying a supplemental budget constraint. The remaining candidate sites from the set of candidate sites constitute the residual incremental subset of candidate sites. The packing and ranking algorithms also identify a residual incremental subset of locations of interest from the set of locations of interest. Locations of interest from which it would be unable to reach the select incremental subset of candidate sites for the select reachability radius are grouped in the residual incremental subset of locations of interest. The packing and ranking algorithms also determine an incremental demand deployment cost based on the corresponding revised site deployment costs for the select incremental subset of candidate sites at the select reachability radius. The packing and ranking algorithms also determine a supplemental remainder budget based on a difference between the supplemental budget constraint and the incremental demand deployment cost. The at least one processor 1402 is configured to process the residual incremental subset of candidate sites, a corresponding residual incremental subset of revised site deployment costs, the packing and covering constraints, and the residual incremental subset of locations of interest using the covering algorithm to identify a further incremental subset of candidate sites from the residual incremental subset of candidate sites. The candidate sites selected for the further incremental subset of candidate sites permit the residual incremental subset of locations of interest to reach services for the select reachability radius. The covering algorithm also determines an incremental covering deployment cost based on the corresponding revised site deployment costs for the further incremental subset of candidate sites at the select reachability radius.

If the incremental covering deployment cost is greater than the supplemental budget constraint, there is no feasible facility deployment option for the select reachability radius and the at least one processor 1402 is configured to continue by selecting a different reachability radius from the reachability radius range and repeating the processing using the packing, ranking, and covering algorithms for the different reachability radius.

If the incremental covering deployment cost is greater than the supplemental remainder budget, the at least one processor 1402 is configured to continue by using a priority ranking associated with satisfaction of the packing, covering, and supplemental budget constraints to move a candidate site with least priority from the select incremental subset of candidate sites to the residual incremental subset of candidate sites. This creates a new select incremental subset of candidate sites and a new residual incremental subset of candidate sites. The at least one processor is configured to identify a new residual incremental subset of locations of interest from the set of locations of interest. Locations of interest from which it would be unable to reach the new select incremental subset of candidate sites for the select reachability radius are grouped in the new residual incremental subset of locations of interest. The at least one processor is configured to determine a new incremental demand deployment cost based on the corresponding revised site deployment costs for the new select incremental subset of candidate sites at the select reachability radius. The at least one processor is configured to determine a new supplemental remainder budget based on a difference between the supplemental budget constraint and the new incremental demand deployment cost. The at least one processor is configured to repeat the processing using the covering algorithm and the new residual incremental subset of candidate sites, a corresponding new residual incremental subset of site deployment costs, the covering constraint, and the new residual incremental subset of locations of interest.

If the incremental covering deployment cost equals the supplemental remainder budget, the select and further incremental subsets of candidate sites and the supplemental service units associated with the corresponding candidate sites form an optimized incremental facility deployment option for the select reachability radius.

If the incremental covering deployment cost is less than the supplemental remainder budget, the at least one processor 1402 is configured to continue by determining a supplemental remainder demand budget based on a difference between the supplemental budget constraint and a sum of the incremental demand and covering deployment costs, identifying a remainder incremental subset of candidate sites based on a difference between the set of candidate sites and a combination of previous select and further subsets of candidate sites and the select and further incremental subsets of candidate sites, and repeating the processing using the packing algorithm to identify a supplemental incremental subset of candidate sites with the supplemental budget constraint adjusted to be the same as the supplemental remainder demand budget. The select, further, and supplemental incremental subsets of candidate sites and the supplemental service units associated with the corresponding candidate sites form the optimized incremental facility deployment option for the select reachability radius.

In yet another embodiment of the facility deployment planning system 1400, the set of site deployment costs is a set of baseline subsidy bids for site deployment costs at each reachability radius in the reachability radius range by an authoritative agency that controls a related competition among the private providers for subsidies from the authoritative agency for the deployment of the corresponding service units at each candidate site for the corresponding reachability radius range. The authoritative agency determines an optimized deployment option that maximizes satisfaction of demand for service and ensures access to reach service within an agency budget constraint and budget constraints from the multiple providers.

In another further embodiment, the at least one processor 1402 is configured to process the set of candidate sites, the reachability radius range, the set of estimated site demands for service, the set of baseline subsidy bids, a corresponding set of provider costs from multiple private providers, an agency packing constraint, packing constraints from multiple providers, and the set of locations of interest using a packing algorithm and a ranking algorithm to identify a select subset of candidate sites, a residual subset of candidate sites from the set of candidate sites, and a select subset of providers from the set of providers. The candidate sites selected for the select subset of candidate sites and the corresponding baseline subsidy bids from the select subset of providers maximize satisfied demand for service at a select reachability radius within the reachability radius range while satisfying the agency budget constraint and budget constraints from the multiple providers. The remaining candidate sites from the set of candidate sites constitute the residual subset of candidate sites. The packing and ranking algorithms also identify a residual subset of locations of interest from the set of locations of interest. Locations of interest from which it would be unable to reach the select subset of candidate sites for the select reachability radius are grouped in the residual subset of locations of interest, The packing and ranking algorithms also determine an agency demand deployment cost based on agency costs for the corresponding baseline subsidy bids for the select subset of candidate sites at the select reachability radius. The packing and ranking algorithms also determine provider demand deployment costs based on the corresponding provider costs for multiple providers in the select subset of providers. The packing and ranking algorithms also determine an agency remainder budget based on a difference between the agency budget constraint and the agency demand deployment cost. The packing and ranking algorithms also determine provider remainder budgets based on differences between provider budget constraints and provider demand deployment costs for multiple providers in the select subset of providers. The at least one processor 1402 is configured to process the residual subset of candidate sites, a corresponding residual subset of baseline subsidy bids, corresponding residual subsets of provider costs from each private provider, the covering constraints, and the residual subset of locations of interest using a covering algorithm to identify a further subset of candidate sites from the residual subset of candidate sites and a further subset of providers from the set of providers. The candidate sites and subsidy bids selected for the further subset of candidate sites permit the residual subset of locations of interest to reach services for the select reachability radius. The covering algorithm also determines an agency covering deployment cost based on agency costs for the corresponding baseline and provider subsidy bids for the further subset of candidate sites at the select reachability radius. The covering algorithm determines provider covering deployment costs based on the corresponding provider costs for multiple providers in the further subset of providers for the further subset of candidate sites at the select reachability radius.

If the agency covering deployment cost is greater than the agency budget constraint or if at least one of the provider covering deployment costs is greater than the corresponding provider budget constraint, there is no feasible facility deployment option for the select reachability radius and the at least one processor 1402 is configured to continue by selecting an alternate reachability radius from the reachability radius range and repeating the processing using the packing, ranking, and covering algorithms for the alternate reachability radius.

If the agency covering deployment cost is greater than the agency remainder budget or if at least one of the provider covering deployment costs is greater than the corresponding provider remainder budget, the at least one processor 1402 is configured to continue by using a priority ranking associated with satisfaction of the packing, covering, and budget constraints to move a candidate site with least priority from the select subset of candidate sites to the residual subset of candidate sites and remove the corresponding provider from the select subset of providers. This creates a new select subset of candidate sites and associated new baseline subsidy bids, a new residual subset of candidate sites, and a new select subset of providers. The at least one processor is configured to identify a new residual subset of locations of interest from the set of locations of interest. Locations of interest from which it would be unable to reach the new select subset of candidate sites for the select reachability radius are grouped in the new residual subset of locations of interest. The at least one processor is configured to determine a new agency demand deployment cost based on agency costs for the corresponding new baseline subsidy bids, and provider demand deployment costs based on the corresponding provider costs for multiple providers in the new select subset of providers, for the new select subset of candidate sites at the select reachability radius. The at least one processor is configured to determine a new agency remainder budget based on a difference between the agency budget constraint and the new agency demand deployment cost, and new provider remainder budgets based on differences between provider budget constraints and new provider demand deployment costs for multiple providers in the new select subset of providers. The at least one processor is configured to repeat the processing using the covering algorithm and the new residual subset of candidate sites, a corresponding new residual subset of baseline subsidy bids, corresponding new residual subset of provider costs from each private provider, the covering constraints, and the new residual subset of locations of interest.

If the agency covering deployment cost equals the agency remainder budget or if at least one of the provider covering deployment costs equals the corresponding provider remainder budget, the select and further subsets of candidate sites, the corresponding select and further subsets of providers, and the service units associated with the corresponding candidate sites form an optimized facility deployment option for the select reachability radius.

If the agency covering deployment cost is less than the agency remainder budget all of the provider covering deployment costs are less than the corresponding provider remainder budgets, the at least one processor 1402 is configured to continue by determining a remainder demand budget based on a difference between the agency budget constraint and a sum of the agency demand and covering deployment costs. The at least one processor is configured to determine provider remainder budgets based on differences between provider budget constraints and provider demand deployment costs for multiple providers in the select and further subsets of providers, The at least one processor is configured to identify a remainder subset of candidate sites based on a difference between the set of candidate sites and a combination of the select and further subsets of candidate sites. The at least one processor is configured to repeat the processing using the packing algorithm to identify a supplemental subset of candidate sites and a corresponding supplemental subset of providers with the agency budget constraint adjusted to be the same as the agency remainder demand budget and the provider budget constraints adjusted to be the same as the provider remainder demand budgets. The select, further, and supplemental subsets of candidate sites, the corresponding select, further, and supplemental subsets of providers, and the service units associated with the corresponding candidate sites form the optimized facility deployment option for the select reachability radius.

With reference to FIGS. 10-14, various exemplary embodiments of non-transitory computer-readable medium storing program instructions that, when executed by at least one processor 1402, cause a corresponding processor-controlled apparatus (e.g., facility deployment planning system 1400) to perform a method of planning for deployment of facilities. For example, various embodiments of the processor-controlled apparatus are described above with reference to FIG. 14. Various embodiments of the method of planning for deployment of facilities are described above with reference to FIGS. 10-13. In other words, the program instructions of the various exemplary embodiments of non-transitory computer-readable medium are defined by any suitable combination of the processes 1000, 1100, 1200, 1300 described above with reference to FIGS. 10-13. Similarly, the at least one processor 1402 and the processor-controlled apparatus associated with the various exemplary embodiments of non-transitory computer-readable medium are defined by any suitable combination of the facility deployment planning system 1400 described above with reference to FIG. 14.

It will be appreciated that variants of the above-disclosed and other features and functions, or alternatives thereof, may be combined into many other different computer platforms, computer applications, or combinations thereof. Various presently unforeseen or unanticipated alternatives, modifications, variations, or improvements therein may be subsequently made by those skilled in the art which are also intended to be encompassed by the following claims.

What is claimed is:

1. A method of planning for deployment of facilities, comprising:
processing a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses;
receiving a set of estimated site demands for service from a demand prediction subsystem, wherein the set of estimated site demands for service includes an estimated site demand for service (dᵢ) for each candidate site of the set of candidate sites;
processing the set of candidate sites, the set of estimated site demands for service, and a service requirement constraint using a queuing algorithm to determine service units (Nᵢ) required to satisfy the service requirement constraint at each candidate site, wherein the determined service units for each candidate site form a set of service unit quantities; and
processing the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.

2. The method of claim 1 wherein the set of reachability radiuses relate to each location of interest such that each reachability radius is a function of distance from the corresponding location of interest, wherein the inner reachability radius is determined such that any radius less than the inner reachability radius would leave at least one location of interest from which it would be unable to reach at least one candidate site, wherein the outer reachability radius is determined such that no distance from any location of interest to any candidate site is greater than the outer reachability radius, wherein the inner reachability radius, outer reachability radius, and each reachability radius therebetween form a reachability radius range.

3. The method of claim 1, further comprising:
processing the set of candidate sites, the reachability radius range, the set of estimated site demands for service, the set of site deployment costs, a packing constraint, and the set of locations of interest using a packing algorithm and a ranking algorithm to i) identify a select subset of candidate sites and a residual subset of candidate sites from the set of candidate sites, wherein the candidate sites selected for the select subset of candidate sites maximize satisfied demand for service at a select reachability radius within the reachability radius range while satisfying a budget constraint, wherein remaining candidate sites from the set of candidate sites constitute the residual subset of candidate sites, ii) identify a residual subset of locations of interest from the set of locations of interest, wherein locations of interest from which it would be unable to reach the select subset of candidate sites for the select reachability radius are grouped in the residual subset of locations of interest, iii) determine a demand deployment cost based on the corresponding site deployment costs for the select subset of candidate sites at the select reachability radius, and iv) determine a remainder budget based on a difference between the budget constraint and the demand deployment cost; and
processing the residual subset of candidate sites, a corresponding residual subset of site deployment costs, a covering constraint, and the residual subset of locations of interest using a covering algorithm to i) identify a further subset of candidate sites from the residual subset of candidate sites, wherein the candidate sites selected for the further subset of candidate sites permit the residual subset of locations of interest to reach services for the select reachability radius and ii) determine a covering deployment cost based on the corresponding site deployment costs for the further subset of candidate sites at the select reachability radius;
wherein, if the covering deployment cost is greater than the agency budget constraint, there is no feasible facility deployment option for the select reachability radius;
wherein, if the covering deployment cost is greater than the reminder budget, the method continues using a priority ranking associated with satisfaction of the packing, covering, and budget constraints to i) move a candidate site with least priority from the select subset of candidate sites to the residual subset of candidate sites, thereby creating a new select subset of candidate sites and a new residual subset of candidate sites, ii) identify a new residual subset of locations of interest from the set of locations of interest, wherein locations of interest from which it would be unable to reach the new select subset of candidate sites for the select reachability radius are grouped in the new residual subset of locations of interest, iii) determine a new demand deployment cost based on the corresponding site deployment costs for the new select subset of candidate sites at the select reachability radius, iv) determine a new remainder budget based on a difference between the budget constraint and the new demand deployment cost, and v) repeating the processing using the covering algorithm and the new residual subset of candidate sites, a corresponding new residual subset of site deployment costs, the covering constraint, and the new residual subset of locations of interest;
wherein, if the covering deployment cost equals the remainder budget, the select and further subsets of candidate sites and the service units associated with the corresponding candidate sites form an optimized facility deployment option for the select reachability radius;
wherein, if the covering deployment cost is less than the remainder budget, the method continues by i) determining a remainder demand budget based on a difference between the budget constraint and a sum of the demand and covering deployment costs, ii) identifying a remainder subset of candidate sites based on a difference between the set of candidate sites and a combination of the select and further subsets of candidate sites, and iii) repeating the processing using the packing algorithm to identify a supplemental subset of candidate sites with the budget constraint adjusted to be the same as the remainder demand budget, wherein the select, further, and supplemental subsets of candidate sites and the service units associated with the corresponding candidate sites form the optimized facility deployment option for the select reachability radius.

4. The method of claim 3, further comprising:
using the packing, ranking, and covering algorithms in the same manner for each reachability radius in the reachability radius range.

5. The method of claim 4, further comprising:
processing a portion of the set of estimated site demands for service corresponding to the select, further, and supplemental subsets of candidate sites for each reachability radius associated with a feasible deployment option, the inner reachability radius, the outer reachability radius, and a weighting factor using a demand-reachability trade-off algorithm to identify an optimized facility deployment option among the feasible deployment option;
wherein the weighting factor ranges between a first value favoring maximizing the satisfied demand for service with limited or no concern for minimizing the reachability radius and a second value favoring minimizing the reachability radius with limited or no concern for maximizing the satisfied demand for service.

6. The method of claim 5, further comprising:
processing the candidate sites, reachability radius, service unit quantities, and site deployment costs associated with the optimized facility deployment option using a report processing algorithm to generate a facility deployment plan that satisfies the service requirement, packing, covering, and budget constraints.

7. The method of claim 3 wherein progressive releases of portions of an overall budget lead to incremental deployment of facilities over an extended time that include an initial time period for which the optimized deployment option and at least one subsequent time period, each subsequent time period resulting in an optimized incremental deployment option based at least in part on using the queuing, site cost, packing, ranking, and covering algorithms with a revised set of estimated site demands for service, revised existing per unit cost data for deployment of service units to candidate sites, and a supplemental budget constraint, the method further comprising:
receiving a revised set of estimated site demands for service from a demand predictions subsystem, wherein the revised set of estimated site demands for service includes a revised estimated site demand for service (dᵢ^{t}) or (dᵢ^{t}−dᵢ^{t-1}) or zero for each candidate site of the set of candidate sites, wherein the revised estimated site demand for candidate sites for which service units were not previously deployed is (dᵢ^{t}) and the revised estimated site demand for candidate sites with service units previously deployed is (dᵢ^{t}−dᵢ^{t-1}) or zero, whichever is larger;
processing the set of candidate sites, the revised set of estimated site demands for service, and the service requirement constraint using the queuing algorithm to determine revised service units (Nᵢ^{t}) or (Nᵢ^{t}−Nᵢ^{t-1}) or zero required to satisfy the service requirement constraint at each candidate site, wherein the revised service units for candidate sites for which service units were not previously deployed are (Nᵢ^{t}) and the revised service units for candidates with service units previously deployed are (Nᵢ^{t}−Nᵢ^{t-1}) or zero, whichever is larger, and represent supplemental service units, wherein the revised determined service units for each candidate site form a revised set of service unit quantities;
processing the set of candidate sites, the revised set of service unit quantities, and the revised existing per unit cost data for deployment of service units to the set of candidate sites using the site cost algorithm to estimate a revised set of site deployment costs including a revised site deployment cost (cᵢ^{t}) or (cᵢ^{t}−cᵢ^{t-1}) or zero for each candidate site, wherein the revised site deployment costs for candidate sites for which service units were not previously deployed are (cᵢ^{t}) and represent costs to obtain the corresponding candidate site and to setup the service units at the corresponding candidate site, wherein the revised site deployment costs for candidate sites with service units previously deployed are (cᵢ^{t}−cᵢ^{t-1}) or zero, whichever is larger, and represent costs to setup the supplemental service units at the corresponding candidate site;
processing the set of candidate sites, the reachability radius range, the revised set of estimated site demands for service, the revised set of site deployment costs, the packing constraint, and the set of locations of interest using the packing algorithm and the ranking algorithm to i) identify a select incremental subset of candidate sites and a residual incremental subset of candidate sites from the set of candidate sites, wherein the candidate sites selected for the select incremental subset of candidate sites maximize satisfied demand for service at a select reachability radius within the reachability radius range while satisfying a supplemental budget constraint, wherein the remaining candidate sites from the set of candidate sites constitute the residual incremental subset of candidate sites, ii) identify a residual incremental subset of locations of interest from the set of locations of interest, wherein locations of interest from which it would be unable to reach the select incremental subset of candidate sites for the select reachability radius are grouped in the residual incremental subset of locations of interest, iii) determine an incremental demand deployment cost based on the corresponding revised site deployment costs for the select incremental subset of candidate sites at the select reachability radius, and iv) determine a supplemental remainder budget based on a difference between the supplemental budget constraint and the incremental demand deployment cost; and
processing the residual incremental subset of candidate sites, a corresponding residual incremental subset of revised site deployment costs, the packing and covering constraints, and the residual incremental subset of locations of interest using the covering algorithm to i) identify a further incremental subset of candidate sites from the residual incremental subset of candidate sites, wherein the candidate sites selected for the further incremental subset of candidate sites permit the residual incremental subset of locations of interest to reach services for the select reachability radius and ii) determine an incremental covering deployment cost based on the corresponding revised site deployment costs for the further incremental subset of candidate sites at the select reachability radius;
wherein, if the incremental covering deployment cost is greater than the supplemental budget constraint, there is no feasible facility deployment option for the select reachability radius and the method continues by selecting a different reachability radius from the reachability radius range and repeating the processing using the packing, ranking, and covering algorithms for the different reachability radius;
wherein, if the incremental covering deployment cost is greater than the supplemental remainder budget, the method continues by using a priority ranking associated with satisfaction of the packing, covering, and supplemental budget constraints to i) move a candidate site with least priority from the select incremental subset of candidate sites to the residual incremental subset of candidate sites, thereby creating a new select incremental subset of candidate sites and a new residual incremental subset of candidate sites, ii) identify a new residual incremental subset of locations of interest from the set of locations of interest, wherein locations of interest from which it would be unable to reach the new select incremental subset of candidate sites for the select reachability radius are grouped in the new residual incremental subset of locations of interest, iii) determine a new incremental demand deployment cost based on the corresponding revised site deployment costs for the new select incremental subset of candidate sites at the select reachability radius, iv) determine a new supplemental remainder budget based on a difference between the supplemental budget constraint and the new incremental demand deployment cost, and v) repeating the processing using the covering algorithm and the new residual incremental subset of candidate sites, a corresponding new residual incremental subset of site deployment costs, the covering constraint, and the new residual incremental subset of locations of interest;
wherein, if the incremental covering deployment cost equals the supplemental remainder budget, the select and further incremental subsets of candidate sites and the supplemental service units associated with the corresponding candidate sites form an optimized incremental facility deployment option for the select reachability radius;
wherein, if the incremental covering deployment cost is less than the supplemental remainder budget, the method continues by i) determining a supplemental remainder demand budget based on a difference between the supplemental budget constraint and a sum of the incremental demand and covering deployment costs, ii) identifying a remainder incremental subset of candidate sites based on a difference between the set of candidate sites and a combination of previous select and further subsets of candidate sites and the select and further incremental subsets of candidate sites, and iii) repeating the processing using the packing algorithm to identify a supplemental incremental subset of candidate sites with the supplemental budget constraint adjusted to be the same as the supplemental remainder demand budget, wherein the select, further, and supplemental incremental subsets of candidate sites and the supplemental service units associated with the corresponding candidate sites form the optimized incremental facility deployment option for the select reachability radius.

8. The method of claim 1 wherein the set of site deployment costs is a set of baseline subsidy bids for site deployment costs at each reachability radius in the reachability radius range by an authoritative agency that controls a competition among the private providers for subsidies from the authoritative agency for the deployment of the corresponding service units at each candidate site for the corresponding reachability radius range, wherein the authoritative agency determines an optimized deployment option that maximizes satisfaction of demand for service and ensures access to reach service within an agency budget constraint and budget constraints from the multiple providers.

9. The method of claim 8, further comprising:
processing the set of candidate sites, the reachability radius range, the set of estimated site demands for service, the set of baseline subsidy bids, a corresponding set of provider costs from multiple private providers, an agency packing constraint, packing constraints from multiple providers, and the set of locations of interest using a packing algorithm and a ranking algorithm to i) identify a select subset of candidate sites, a residual subset of candidate sites from the set of candidate sites, and a select subset of providers from the set of providers, wherein the candidate sites selected for the select subset of candidate sites and the corresponding baseline subsidy bids from the select subset of providers maximize satisfied demand for service at a select reachability radius within the reachability radius range while satisfying the agency budget constraint and budget constraints from the multiple providers, wherein the remaining candidate sites from the set of candidate sites constitute the residual subset of candidate sites, ii) identify a residual subset of locations of interest from the set of locations of interest, wherein locations of interest from which it would be unable to reach the select subset of candidate sites for the select reachability radius are grouped in the residual subset of locations of interest, iii) determine an agency demand deployment cost based on agency costs for the corresponding baseline subsidy bids for the select subset of candidate sites at the select reachability radius, iv) determine provider demand deployment costs based on the corresponding provider costs for multiple providers in the select subset of providers, v) determine an agency remainder budget based on a difference between the agency budget constraint and the agency demand deployment cost, and vi) determine provider remainder budgets based on differences between provider budget constraints and provider demand deployment costs for multiple providers in the select subset of providers; and
processing the residual subset of candidate sites, a corresponding residual subset of baseline subsidy bids, corresponding residual subsets of provider costs from each private provider, the covering constraints, and the residual subset of locations of interest using a covering algorithm to i) identify a further subset of candidate sites from the residual subset of candidate sites and a further subset of providers from the set of providers, wherein the candidate sites selected for the further subset of candidate sites permit the residual subset of locations of interest to reach services for the select reachability radius, ii) determine an agency covering deployment cost based on agency costs for the corresponding baseline subsidy bids for the further subset of candidate sites at the select reachability radius, and iii) determine provider covering deployment costs based on the corresponding provider costs for multiple providers in the further subset of providers for the further subset of candidate sites at the select reachability radius;
wherein, if the agency covering deployment cost is greater than the agency budget constraint or if at least one of the provider covering deployment costs is greater than the corresponding provider budget constraint, there is no feasible facility deployment option for the select reachability radius and the method continues by selecting an alternate reachability radius from the reachability radius range and repeating the processing using the packing, ranking, and covering algorithms for the alternate reachability radius;
wherein, if the agency covering deployment cost is greater than the agency remainder budget or if at least one of the provider covering deployment costs is greater than the corresponding provider remainder budget, the method continues by using a priority ranking associated with satisfaction of the packing, covering, and budget constraints to i) move a candidate site with least priority from the select subset of candidate sites to the residual subset of candidate sites and remove the corresponding provider from the select subset of providers, thereby creating a new select subset of candidate sites and associated new baseline subsidy bids, a new residual subset of candidate sites, and a new select subset of providers, ii) identify a new residual subset of locations of interest from the set of locations of interest, wherein locations of interest from which it would be unable to reach the new select subset of candidate sites for the select reachability radius are grouped in the new residual subset of locations of interest, iii) determine a new agency demand deployment cost based on agency costs for the corresponding new baseline subsidy bids, and provider demand deployment costs based on the corresponding provider costs for multiple providers in the new select subset of providers, for the new select subset of candidate sites at the select reachability radius, iv) determine a new agency remainder budget based on a difference between the agency budget constraint and the new agency demand deployment cost, and new provider remainder budgets based on differences between provider budget constraints and new provider demand deployment costs for multiple providers in the new select subset of providers, and v) repeating the processing using the covering algorithm and the new residual subset of candidate sites, a corresponding new residual subset of baseline subsidy bids, corresponding new residual subset of provider costs from each private provider, the covering constraints, and the new residual subset of locations of interest;
wherein, if the agency covering deployment cost equals the agency remainder budget or if at least one of the provider covering deployment costs equals the corresponding provider remainder budget, the select and further subsets of candidate sites, the corresponding select and further subsets of providers, and the service units associated with the corresponding candidate sites form an optimized facility deployment option for the select reachability radius;
wherein, if the agency covering deployment cost is less than the agency remainder budget and all of the provider covering deployment costs are less than the corresponding provider remainder budgets, the method continues by i) determining a remainder demand budget based on a difference between the agency budget constraint and a sum of the agency demand and covering deployment costs, ii) determining provider remainder budgets based on differences between provider budget constraints and provider demand deployment costs for multiple providers in the select and further subsets of providers, iii) identifying a remainder subset of candidate sites based on a difference between the set of candidate sites and a combination of the select and further subsets of candidate sites, and iv) repeating the processing using the packing algorithm to identify a supplemental subset of candidate sites and a corresponding supplemental subset of providers with the agency budget constraint adjusted to be the same as the agency remainder demand budget and the provider budget constraints adjusted to be the same as the provider remainder demand budgets, wherein the select, further, and supplemental subsets of candidate sites, the corresponding select, further, and supplemental subsets of providers, and the service units associated with the corresponding candidate sites form the optimized facility deployment option for the select reachability radius.

10. An apparatus to facilitate planning for deployment of facilities, comprising:
at least one processor and associated memory; and
a non-transitory storage device configured to store program instructions that, when executed by the at least one processor, cause the apparatus to perform a method of planning for deployment of facilities;
wherein the at least one processor is configured to process a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses;
wherein the at least one processor is configured to receive a set of estimated site demands for service from a demand prediction subsystem, wherein the set of estimated site demands for service includes an estimated site demand for service (dᵢ) for each candidate site of the set of candidate sites;
wherein the at least one processor is configured to process the set of candidate sites, the set of estimated site demands for service, and a service requirement constraint using a queuing algorithm to determine service units (Nᵢ) required to satisfy the service requirement constraint at each candidate site, wherein the determined service units for each candidate site at each reachability radius form a set of service unit quantities;
wherein the at least one processor is configured to process the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.

11. The apparatus of claim 10 wherein the set of reachability radiuses relate to each location of interest such that each reachability radius is a function of distance from the corresponding location of interest, wherein the inner reachability radius is determined such that any radius less than the inner reachability radius would leave at least one location of interest from which it would be unable to reach at least one candidate site, wherein the outer reachability radius is determined such that no distance from any location of interest to any candidate site is greater than the outer reachability radius, wherein the inner reachability radius, outer reachability radius, and each reachability radius therebetween form a reachability radius range.

12. The apparatus of claim 10 wherein the service units comprise at least one of electric vehicle charging stations, bus stop shelters, parking lots, and healthcare kiosks.

13. The apparatus of claim 10, wherein the at least one processor is configured to process the set of candidate sites, the reachability radius range, the set of estimated site demands for service, the set of site deployment costs, a packing constraint, and the set of locations of interest using a packing algorithm and a ranking algorithm to i) identify a select subset of candidate sites and a residual subset of candidate sites from the set of candidate sites, wherein the candidate sites selected for the select subset of candidate sites maximize satisfied demand for service at a select reachability radius within the reachability radius range while satisfying a budget constraint, wherein remaining candidate sites from the set of candidate sites constitute the residual subset of candidate sites, ii) identify a residual subset of locations of interest from the set of locations of interest, wherein locations of interest from which it would be unable to reach the select subset of candidate sites for the select reachability radius are grouped in the residual subset of locations of interest, iii) determine a demand deployment cost based on the corresponding site deployment costs for the select subset of candidate sites at the select reachability radius, and iv) determine a remainder budget based on a difference between the budget constraint and the demand deployment cost;
wherein the at least one processor is configured to process the residual subset of candidate sites, a corresponding residual subset of site deployment costs, a covering constraint, and the residual subset of locations of interest using a covering algorithm to i) identify a further subset of candidate sites from the residual subset of candidate sites, wherein the candidate sites selected for the further subset of candidate sites permit the residual subset of locations of interest to reach services for the select reachability radius and ii) determine a covering deployment cost based on the corresponding site deployment costs for the further subset of candidate sites at the select reachability radius;
wherein, if the covering deployment cost is greater than the agency budget constraint, there is no feasible facility deployment option for the select reachability radius;
wherein, if the covering deployment cost is greater than the reminder budget, the at least one processor is configured to continue using a priority ranking associated with satisfaction of the packing, covering, and budget constraints to i) move a candidate site with least priority from the select subset of candidate sites to the residual subset of candidate sites, thereby creating a new select subset of candidate sites and a new residual subset of candidate sites, ii) identify a new residual subset of locations of interest from the set of locations of interest, wherein locations of interest from which it would be unable to reach the new select subset of candidate sites for the select reachability radius are grouped in the new residual subset of locations of interest, iii) determine a new demand deployment cost based on the corresponding site deployment costs for the new select subset of candidate sites at the select reachability radius, iv) determine a new remainder budget based on a difference between the budget constraint and the new demand deployment cost, and v) repeating the processing using the covering algorithm and the new residual subset of candidate sites, a corresponding new residual subset of site deployment costs, the covering constraint, and the new residual subset of locations of interest;
wherein, if the covering deployment cost equals the remainder budget, the select and further subsets of candidate sites and the service units associated with the corresponding candidate sites form an optimized facility deployment option for the select reachability radius;
wherein, if the covering deployment cost is less than the remainder budget, the at least one processor is configured to continues by i) determining a remainder demand budget based on a difference between the budget constraint and a sum of the demand and covering deployment costs, ii) identifying a remainder subset of candidate sites based on a difference between the set of candidate sites and a combination of the select and further subsets of candidate sites, and iii) repeating the processing using the packing algorithm to identify a supplemental subset of candidate sites with the budget constraint adjusted to be the same as the remainder demand budget, wherein the select, further, and supplemental subsets of candidate sites and the service units associated with the corresponding candidate sites form the optimized facility deployment option for the select reachability radius.

14. The apparatus of claim 13 wherein the at least one processor is configured to use the packing, ranking, and covering algorithms in the same manner for each reachability radius in the reachability radius range.

15. The apparatus of claim 14 wherein the at least one processor is configured to process a portion of the set of estimated site demands for service corresponding to the select, further, and supplemental subsets of candidate sites for each reachability radius associated with a feasible deployment option, the inner reachability radius, the outer reachability radius, and a weighting factor using a demand-reachability trade-off algorithm to identify an optimized facility deployment option among the feasible deployment option;
wherein the weighting factor ranges between a first value favoring maximizing the satisfied demand for service with limited or no concern for minimizing the reachability radius and a second value favoring minimizing the reachability radius with limited or no concern for maximizing the satisfied demand for service.

16. The apparatus of claim 15 wherein the at least one processor is configured to process the candidate sites, reachability radius, service unit quantities, and site deployment costs associated with the optimized facility deployment option using a report processing algorithm to generate a facility deployment plan that satisfies the service requirement, packing, covering, and budget constraints.

17. The apparatus of claim 13 wherein progressive releases of portions of an overall budget lead to incremental deployment of facilities over an extended time that include an initial time period for which the optimized deployment option and at least one subsequent time period, each subsequent time period resulting in an optimized incremental deployment option based at least in part on using the queuing, site cost, packing, ranking, and covering algorithms with a revised set of estimated site demands for service, revised existing per unit cost data for deployment of service units to candidate sites, and a supplemental budget constraint;
wherein the at least one processor is configured to receive a revised set of estimated site demands for service from a demand predictions subsystem, wherein the revised set of estimated site demands for service includes a revised estimated site demand for service (dᵢ^{t}) or (dᵢ^{t}−dᵢ^{t-1}) or zero for each candidate site of the set of candidate sites, wherein the revised estimated site demand for candidate sites for which service units were not previously deployed is (dᵢ^{t}) and the revised estimated site demand for candidate sites with service units previously deployed is (dᵢ^{t}−dᵢ^{t-1}) or zero, whichever is larger;
wherein the at least one processor is configured to process the set of candidate sites, the revised set of estimated site demands for service, and the service requirement constraint using the queuing algorithm to determine revised service units (Nᵢ^{t}) or (Nᵢ^{t}−Nᵢ^{t-1}) or zero required to satisfy the service requirement constraint at each candidate site, wherein the revised service units for candidate sites for which service units were not previously deployed are (Nᵢ^{t}) and the revised service units for candidates with service units previously deployed are (Nᵢ^{t}−Nᵢ^{t-1}) or zero, whichever is larger, and represent supplemental service units, wherein the revised determined service units for each candidate site form a revised set of service unit quantities;
wherein the at least one processor is configured to process the set of candidate sites, the revised set of service unit quantities, and the revised existing per unit cost data for deployment of service units to the set of candidate sites using the site cost algorithm to estimate a revised set of site deployment costs including a revised site deployment cost (cᵢ^{t}) or (cᵢ^{t}−cᵢ^{t-1}) or zero for each candidate site, wherein the revised site deployment costs for candidate sites for which service units were not previously deployed are (cᵢ^{t}) and represent costs to obtain the corresponding candidate site and to setup the service units at the corresponding candidate site, wherein the revised site deployment costs for candidate sites with service units previously deployed are (cᵢ^{t}−cᵢ^{t-1}) or zero, whichever is larger, and represent costs to setup the supplemental service units at the corresponding candidate site;
wherein the at least one processor is configured to process the set of candidate sites, the reachability radius range, the revised set of estimated site demands for service, the revised set of site deployment costs, the packing constraint, and the set of locations of interest using the packing algorithm and the ranking algorithm to i) identify a select incremental subset of candidate sites and a residual incremental subset of candidate sites from the set of candidate sites, wherein the candidate sites selected for the select incremental subset of candidate sites maximize satisfied demand for service at a select reachability radius within the reachability radius range while satisfying a supplemental budget constraint, wherein the remaining candidate sites from the set of candidate sites constitute the residual incremental subset of candidate sites, ii) identify a residual incremental subset of locations of interest from the set of locations of interest, wherein locations of interest from which it would be unable to reach the select incremental subset of candidate sites for the select reachability radius are grouped in the residual incremental subset of locations of interest, iii) determine an incremental demand deployment cost based on the corresponding revised site deployment costs for the select incremental subset of candidate sites at the select reachability radius, and iv) determine a supplemental remainder budget based on a difference between the supplemental budget constraint and the incremental demand deployment cost;
wherein the at least one processor is configured to process the residual incremental subset of candidate sites, a corresponding residual incremental subset of revised site deployment costs, the packing and covering constraints, and the residual incremental subset of locations of interest using the covering algorithm to i) identify a further incremental subset of candidate sites from the residual incremental subset of candidate sites, wherein the candidate sites selected for the further incremental subset of candidate sites permit the residual incremental subset of locations of interest to reach services for the select reachability radius and ii) determine an incremental covering deployment cost based on the corresponding revised site deployment costs for the further incremental subset of candidate sites at the select reachability radius;
wherein, if the incremental covering deployment cost is greater than the supplemental budget constraint, there is no feasible facility deployment option for the select reachability radius and the at least one processor is configured to select a different reachability radius from the reachability radius range and repeating the processing using the packing, ranking, and covering algorithms for the different reachability radius;
wherein, if the incremental covering deployment cost is greater than the supplemental remainder budget, the at least one processor is configured to use a priority ranking associated with satisfaction of the packing, covering, and supplemental budget constraints to i) move a candidate site with least priority from the select incremental subset of candidate sites to the residual incremental subset of candidate sites, thereby creating a new select incremental subset of candidate sites and a new residual incremental subset of candidate sites, ii) identify a new residual incremental subset of locations of interest from the set of locations of interest, wherein locations of interest from which it would be unable to reach the new select incremental subset of candidate sites for the select reachability radius are grouped in the new residual incremental subset of locations of interest, iii) determine a new incremental demand deployment cost based on the corresponding revised site deployment costs for the new select incremental subset of candidate sites at the select reachability radius, iv) determine a new supplemental remainder budget based on a difference between the supplemental budget constraint and the new incremental demand deployment cost, and v) repeating the processing using the covering algorithm and the new residual incremental subset of candidate sites, a corresponding new residual incremental subset of site deployment costs, the covering constraint, and the new residual incremental subset of locations of interest;
wherein, if the incremental covering deployment cost equals the supplemental remainder budget, the select and further incremental subsets of candidate sites and the supplemental service units associated with the corresponding candidate sites form an optimized incremental facility deployment option for the select reachability radius;
wherein, if the incremental covering deployment cost is less than the supplemental remainder budget, the at least one processor is configured to continue by i) determining a supplemental remainder demand budget based on a difference between the supplemental budget constraint and a sum of the incremental demand and covering deployment costs, ii) identifying a remainder incremental subset of candidate sites based on a difference between the set of candidate sites and a combination of previous select and further subsets of candidate sites and the select and further incremental subsets of candidate sites, and iii) repeating the processing using the packing algorithm to identify a supplemental incremental subset of candidate sites with the supplemental budget constraint adjusted to be the same as the supplemental remainder demand budget, wherein the select, further, and supplemental incremental subsets of candidate sites and the supplemental service units associated with the corresponding candidate sites form the optimized incremental facility deployment option for the select reachability radius.

18. The apparatus of claim 10 wherein the set of site deployment costs is a set of baseline subsidy bids for site deployment costs at each reachability radius in the reachability radius range by an authoritative agency that controls a related competition among the private providers for subsidies from the authoritative agency for the deployment of the corresponding service units at each candidate site for the corresponding reachability radius range, wherein the authoritative agency determines an optimized deployment option that maximizes satisfaction of demand for service and ensures access to reach service within an agency budget constraint and budget constraints from the multiple providers.

19. The apparatus of claim 18 wherein the at least one processor is configured to process the set of candidate sites, the reachability radius range, the set of estimated site demands for service, the set of baseline subsidy bids, a corresponding set of provider costs from multiple private providers, an agency packing constraint, packing constraints from multiple providers, and the set of locations of interest using a packing algorithm and a ranking algorithm to i) identify a select subset of candidate sites, a residual subset of candidate sites from the set of candidate sites, and a select subset of providers from the set of providers, wherein the candidate sites selected for the select subset of candidate sites and the corresponding baseline subsidy bids from the select subset of providers maximize satisfied demand for service at a select reachability radius within the reachability radius range while satisfying the agency budget constraint and budget constraints from the multiple providers, wherein the remaining candidate sites from the set of candidate sites constitute the residual subset of candidate sites, ii) identify a residual subset of locations of interest from the set of locations of interest, wherein locations of interest from which it would be unable to reach the select subset of candidate sites for the select reachability radius are grouped in the residual subset of locations of interest, iii) determine an agency demand deployment cost based on agency costs for the corresponding baseline subsidy bids for the select subset of candidate sites at the select reachability radius, iv) determine provider demand deployment costs based on the corresponding provider costs for multiple providers in the select subset of providers, v) determine an agency remainder budget based on a difference between the agency budget constraint and the agency demand deployment cost, and vi) determine provider remainder budgets based on differences between provider budget constraints and provider demand deployment costs for multiple providers in the select subset of providers;
wherein the at least one processor is configured to process the residual subset of candidate sites, a corresponding residual subset of baseline subsidy bids, corresponding residual subsets of provider costs from each private provider, the covering constraints, and the residual subset of locations of interest using a covering algorithm to i) identify a further subset of candidate sites from the residual subset of candidate sites and a further subset of providers from the set of providers, wherein the candidate sites selected for the further subset of candidate sites permit the residual subset of locations of interest to reach services for the select reachability radius, ii) determine an agency covering deployment cost based on agency costs for the corresponding baseline subsidy bids for the further subset of candidate sites at the select reachability radius, and iii) determine provider covering deployment costs based on the corresponding provider costs for multiple providers in the further subset of providers for the further subset of candidate sites at the select reachability radius;
wherein, if the agency covering deployment cost is greater than the agency budget constraint or if at least one of the provider covering deployment costs is greater than the corresponding provider budget constraint, there is no feasible facility deployment option for the select reachability radius and the at least one processor is configured to select an alternate reachability radius from the reachability radius range and repeating the processing using the packing, ranking, and covering algorithms for the alternate reachability radius;
wherein, if the agency covering deployment cost is greater than the agency remainder budget or if at least one of the provider covering deployment costs is greater than the corresponding provider remainder budget, the at least one processor is configured to use a priority ranking associated with satisfaction of the packing, covering, and budget constraints to i) move a candidate site with least priority from the select subset of candidate sites to the residual subset of candidate sites and remove the corresponding provider from the select subset of providers, thereby creating a new select subset of candidate sites and associated new baseline subsidy bids, a new residual subset of candidate sites, and a new select subset of providers, ii) identify a new residual subset of locations of interest from the set of locations of interest, wherein locations of interest from which it would be unable to reach the new select subset of candidate sites for the select reachability radius are grouped in the new residual subset of locations of interest, iii) determine a new agency demand deployment cost based on agency costs for the corresponding new baseline subsidy bids, and provider demand deployment costs based on the corresponding provider costs for multiple providers in the new select subset of providers, for the new select subset of candidate sites at the select reachability radius, iv) determine a new agency remainder budget based on a difference between the agency budget constraint and the new agency demand deployment cost, and new provider remainder budgets based on differences between provider budget constraints and new provider demand deployment costs for multiple providers in the new select subset of providers, and v) repeating the processing using the covering algorithm and the new residual subset of candidate sites, a corresponding new residual subset of baseline subsidy bids, corresponding new residual subset of provider costs from each private provider, the covering constraints, and the new residual subset of locations of interest;
wherein, if the agency covering deployment cost equals the agency remainder budget or if at least one of the provider covering deployment costs equals the corresponding provider remainder budget, the select and further subsets of candidate sites, the corresponding select and further subsets of providers, and the service units associated with the corresponding candidate sites form an optimized facility deployment option for the select reachability radius;
wherein, if the agency covering deployment cost is less than the agency remainder budget and all of the provider covering deployment costs are less than the corresponding provider remainder budgets, the at least one processor is configured to continue by i) determining a remainder demand budget based on a difference between the agency budget constraint and a sum of the agency demand and covering deployment costs, ii) determining provider remainder budgets based on differences between provider budget constraints and provider demand deployment costs for multiple providers in the select and further subsets of providers, ii) identifying a remainder subset of candidate sites based on a difference between the set of candidate sites and a combination of the select and further subsets of candidate sites, and iii) repeating the processing using the packing algorithm to identify a supplemental subset of candidate sites and a corresponding supplemental subset of providers with the agency budget constraint adjusted to be the same as the agency remainder demand budget and the provider budget constraints adjusted to be the same as the provider remainder demand budgets, wherein the select, further, and supplemental subsets of candidate sites, the corresponding select, further, and supplemental subsets of providers, and the service units associated with the corresponding candidate sites form the optimized facility deployment option for the select reachability radius.

20. A non-transitory computer-readable medium storing program instructions that, when executed by at least one processor, cause a corresponding processor-controlled apparatus to perform a method of planning for deployment of facilities, the method comprising:
processing a set of candidate sites ( [symbol] ) and a set of locations of interest ( [symbol] ) using a distance algorithm to determine a set of reachability radiuses ( [symbol] ), an inner reachability radius (R^{min}), and an outer reachability radius (R^{max}), wherein each candidate site (i) is a member of the set of candidate sites, wherein each location of interest (l) is a member of the set of locations of interest, wherein each reachability radius (r) is a member of the set of reachability radiuses;
receiving a set of estimated site demands for service from a demand prediction subsystem, wherein the set of estimated site demands for service includes an estimated site demand for service (dᵢ) for each candidate site of the set of candidate sites;
processing the set of candidate sites, the set of estimated site demands for service, and a service requirement constraint using a queuing algorithm to determine service units (Nᵢ) required to satisfy the service requirement constraint at each candidate site, wherein the determined service units for each candidate site form a set of service unit quantities; and
processing the set of candidate sites, the set of service unit quantities, and existing per unit cost data for deployment of service units to the set of candidate sites using a site cost algorithm to estimate a set of site deployment costs including a site deployment cost (cᵢ) for each candidate site, wherein each site deployment cost represents costs to obtain the corresponding candidate site and to setup the service units at the corresponding candidate site.
